(19) United States
(12) Patent Application Publication
(10) Pub. No.: US 2001/0018717 A1
(43) Pub. Date: Aug. 30, 2001

(54) Computer system, operating system switching system, operating system mounting method, operating system switching method, storage medium, and program transmission apparatus

(75) Inventor: Susumu Shimotono, Hadano-shi (JP)

Correspondence Address: Floyd A. Gonzalez, IBM Corporation, 2455 South Road, P386, Poughkeepsie, NY, 12601, US

(73) Assignee: INTERNATIONAL BUSINESS MACHINES CORPORATION, Armonk, NY (US)

(21) Appl. No.: 09/793,038

(22) Filed: Feb. 26, 2001

(30) Foreign Application Priority Data
Feb. 29, 2000 (JP) 2000-054064

(51) Int. Cl. G06F 9/00; G06F 9/46

(52) U.S. Cl. 709/319

(57) ABSTRACT

A computer system on which a plurality of operating systems are mounted, comprises: a memory device, which has a memory area that is logically divided to obtain a plurality of operating system memory areas 102 and 103, each of which respectively corresponds to one of the operating systems, and an independent memory area 104 that does not correspond to any of the operating systems; interface means, which is employed by the operating system, for issuing an instruction for changing the current operating system; suspend control means; resume control means; and operating system switching means, for receiving from the interface means an instruction to switch operating systems, and for, when an operating system for which a switching instruction has been issued is suspended, resuming the use of a different operating system that is designated in the instruction.

### FIELD OF THE INVENTION

The present invention relates to a system control technique for switching among and employing a plurality of coexisting operating systems available in a single computer system.

### BACKGROUND OF THE INVENTION

As the environment in which computers are employed has grown, an application mode has appeared in which it is possible for a plurality of operating systems (hereinafter referred to as OSs) to coexist in a single computer system, and for these OSs to be selectively and individually employed. According to one presently available conventional method for employing a system composed of a number of different OSs, a specific OS is selected at boot time and is then run as an independent entity. According to another method, a single OS is used as a base and other OSs are run on top of it as emulation programs.

According to the method that provides for OSs to be selected at boot time, when a computer is booted by a user, from among a plurality of available OSs the user manually selects and activates a desired OS. A tool that supports this method is generally called a boot selector, and many such tools are distributed as independent applications or as incorporated OS functions.

Roughly three types of boot selector tools are available.

(1) As is done normally, when ROM code shifts system control to a specific OS, the head sector (the MBR: Master Boot Record) of a hard disk is mechanically accessed, and the contents of the sector are loaded into a memory area at a predetermined address. Then, program control is transferred to the head of the loaded image. However, to switch to another OS this processing sequence is preempted, i.e., the contents of the MBR are altered in advance (replaced), by replacing the first step of the OS activation operation with a procedure that permits the selection and activation of one of a plurality of OSs.

(2) The boot selector is temporarily activated as a boot loader for a predetermined OS, and then another OS is activated as a result of a substitution performed by the boot loader.

(3) The boot selector occupies a unique basic region as an activation partition, and although one OS, as viewed from the ROM code, is first activated, subsequently another OS is activated.

According to all of these OS switching methods, the images of the individual OSs are stored in independent partitions on a hard disk, and boot selectors are provided that can activate only an OS that is stored in a specific partition, that can select and activate an OS that is stored in the only partition on a single hard disk, and that can select and activate an OS that is stored in specific partitions on a plurality of hard disks.

According to the method by which emulation is used to provide for a base OS the functions of another, predetermined OS, a virtual operating environment for the predetermined OS is constructed within the operating environment of the base OS, and even an application for which the predetermined OS environment is an imperative can be run in the environment provided by the base OS. That is, in accordance with this method, a plurality of OSs do not coexist; a layer is simply implemented that provides functions equivalent to a service provision layer, so that an application that depends on the services provided (via an API: Application Program Interface) by an OS can be run by another OS.

The conventional technique by which a plurality of OSs in a single system are switched and employed has the following problem.

According to the method for changing the OSs at boot time, while the coexistence of a plurality of OSs in a single system is implemented, the OSs are changed by rebooting, so that in each instance an extended period of time is required. That is, to change OSs, the processing sequence includes shutting down a currently running OS, activating the ROM and then activating the next OS, and thus, before the OSs can finally be switched, a finite period of time is required to perform each, individual process. Therefore, in this case, usability is inferior.

Further, when the OSs are to be changed, the currently running OS must be shut down, so that effectively the operation is returned to the default state. Therefore, even when during an OS change the OS that was previously employed is again selected, the state (context) existing immediately before the OS change, which was not stored, is lost. Thus, for a user who employs a plurality of OSs and frequently switches among them, usability is extremely inferior. For example, for an application that was being run immediately before an OS change occurred, the data file being processed is effectively terminated and stored when the OS is changed. Then, when recovery to a pertinent OS is effected, it is necessary to again activate the application that was terminated, and to read the data file and to manually return the processing to the proper position on a target page. The switching of OSs during the employment of a series of jobs is equivalent to the halting of a job. Therefore, in this environment, a plurality of applications inherent to the individual OSs can not be employed so that they can interact with each other via the available data files.

According to the method for providing the function of a specific OS for another OS through emulation, OSs do not coexist in the system, but instead, the operating environments for a plurality of OSs are constructed using emulation virtually, so that among the OSs compatibility does not fully exist.

Further, the compatibility of a virtual OS environment that is constructed as an application layer must be maintained or examined in accordance with each upgrading of the version of the specific OS.

In addition, since the independent operating environments of the OSs do not in actuality coexist, the system service inherent to an OS can not be utilized, and an application server that employs as a premise resources inherent to the OS, and a device and its device driver that are operated in a kernel domain, can not be run in the virtual environment.

### SUMMARY OF THE INVENTION

It is, therefore, one object of the present invention to provide an environment wherein for employment, switching among a plurality of operating systems coexisting in a single system can be performed at high speed.

It is another object of the present invention to store the state of an OS that is being employed before a switch is effected to one of a plurality of other OSs that coexist in a single system, and to recover the stored state of the pertinent OS when another OS switch is made.

To achieve the above objects, according to the present invention, a computer system on which a plurality of operating systems are mounted and that switches among and employs the plurality of operating systems, comprises: a memory device, which has a memory area that is logically divided to obtain a plurality of operating system memory areas, each of which respectively corresponds to one of the plurality of operating systems, and an independent memory area that does not correspond to any of the plurality of operating systems; interface, which is operated by each of the plurality of operating systems that are independently loaded into the operating system memory areas, for issuing an instruction for changing the current operating system; suspend controller, which is operated by each of the operating systems that are independently loaded into the operating system memory areas, for storing, in an operating system memory area assigned to an initial operating system, information concerning the operational context of the initial operating system and for temporarily halting the initial operating system; resume controller, which is operated by each of the operating systems that are independently loaded into the operating system memory areas, for shifting to an operating state the initial operating system that has been temporarily shifted to the halted state and for employing the information, which concerns the operational context of the initial operating system that is stored in the operating system memory area, to recover the operational context that existed immediately before the initial operating system was temporarily shifted to the halted state; and operating system switch, which is operated independently of all of the operating systems, for receiving from the interface an instruction to switch the operating systems, and for, when an operating system that has issued the switching instruction is temporarily shifted to the halted state by the suspend controller, employing resume controller, of a different operating system that is designated in the instruction, to shift the different operating system to an operating state.

When a specific memory area of the memory areas controlled by the memory device is repetitively employed by the plurality of operating systems, before the different operating system is shifted to the operating state, the operating system switch withdraws, to the independent memory area or to a primary storage device, the contents of the specific memory area that were loaded by the operating system that was temporarily shifted to the halted state. That is, when of the areas that are assigned to the memory device, one specific memory area must consistently be employed by a plurality of operating systems, this area is repetitively employed. Thus, when operating systems are switched, the contents of this area, which is currently being employed by an operating system, must be retracted and stored in another location; the area must be cleared for the next operating system. As a destination for the retracted contents, the independent memory area assigned to the memory device or a secondary storage device can be employed.

This arrangement is superior because operating systems can coexist in the memory device even when they repetitively employ the same specific area. The data retracted and stored in the independent memory area assigned to the memory device or in the secondary storage device are restored to the original memory area (i.e., the repetitively used area) before the operating system that has been temporarily halted is re-activated by the resume controller.

The withdrawal and restoration method using the secondary storage device is superior, because when a memory area that is repetitively used by multiple OSs is large, a large independent memory area need not be obtained. The withdrawal and restoration method using only the independent memory area is superior for use with high processing speeds.

According to the present invention, a computer system, on which a plurality of operating systems are mounted and which switches among and employs the operating systems, comprises: a memory device, which has a memory area that is logically divided to obtain a plurality of operating system memory areas, each of which respectively corresponds to one of the plurality of operating systems, and an independent memory area that does not correspond to any of the plurality of operating systems; virtual memory manager, for acquiring, as virtual memory, a memory area into which a main operating system, which, when the computer system is activated, is booted and occupies a corresponding operating system memory area, loads another operating system; suspend controller, for storing, in the operating system memory area, information concerning the operational context of the initial operating system, and for temporarily halting the operating system; and resume controller, for shifting the operating system that is temporarily halted to an operating state, and for employing the information, which concerns the operational context of the initial operating system that is stored in the operating system memory area, to restore the operational context that was retracted immediately before the initial operating system was shifted to the temporarily halted state, wherein, when the main operating system is changed to a different operating system, the virtual memory manager obtains a virtual memory area for the different operating system, wherein the suspend controller temporarily halts the main operating system, and the different operating system is loaded into the virtual memory area, and wherein, when the different operating system is to be replaced by the main operating system, the resume controller waits until the different operating system is halted, and then shifts the main operating system into an operating state.

In order to hold the memory area into which another operating system is loaded, the suspend function and the resume function must be employed to replace the main operating system with another operating system. This other operating system may then employ the suspend function and the resume function, or a shut-down and reboot operation to change to a different operating system or to the main operating system.

According to the present invention, for a computer system in which a plurality of operating systems are mounted, a system for switching the operating systems that are to be used comprises: a memory device, which has a memory area that is logically divided to obtain a plurality of operating system memory areas, each of which respectively corresponds to one of the plurality of operating systems, and an independent memory area that does not correspond to any of the plurality of operating systems; and operating system switch, for switching an operating system that is loaded in one of the operating system memory areas with an operating system that is loaded in the independent memory area, wherein, for an operating system having a suspend function that stores, in an operating system memory area assigned for an initial operating system, information concerning the operational context of the initial operating system and that temporarily halts the initial operating system, and having a resume function that shifts the initial operating system that is temporarily halted to an operating state and that employs the information concerning the operational context of the initial operating system to restore the operational context that existed immediately before the initial operating system was temporarily shifted to the halted state, when, for use, the operating system switch employs the suspend function to temporarily halt the initial operating system in order to change from the initial operating system to a different operating system, and wherein the operating system switch employs the resume function to shift the initial operating system to the operating state in order to change from the different operating system to the initial operating system.

For an operating system that does not have the suspend function and the resume function, the operating system switch independently shuts down and halts the operating system in order, for use, to change from the operating system to a different operating system, or reboots the operating system and shifts to the different operating system in order to change from the different operating system to the operating system.

Since the shut-down and rebooting operation is employed to switch operating systems, the operational context can not be stored. Further, the time required for switching the operating systems is extended, compared with when the suspend and resume functions are employed. On the other hand, the advantage provided by the employment of the shut-down and rebooting operation is that the present invention can also be applied for operating systems that do not support the suspend and resume functions when the present invention is mounted. Especially when the operational context need not be stored, or for an OS that can quickly perform the shut-down and rebooting operation, even the shut-down and rebooting operation is satisfactorily effective for the switching of operating systems.

According to the present invention, for a computer system in which a plurality of operating systems are mounted and which switches among and employs the operating systems, an operating system mounting method comprises the steps of: loading, into a predetermined memory area belonging to a memory device, means for exercising overall control, which is a program module for totally controlling the booting and switching of the plurality of operating systems; and sequentially loading, under the control of the means for exercising overall control, the operating systems into a plurality of operating system memory areas in the memory device that respectively correspond to the operating systems, whereof the step of sequentially loading the operating systems includes the steps of employing a boot loader for a specific operating system to boot each of the operating systems in a corresponding operating system memory area, halting the operating system that has been booted when there is a different operating system to be loaded, and initializing, after the operating system has been halted, hardware components, other than the memory device and a memory controller, to shift program control to a process for loading the different operating system.

The logical divided memory segments in the operating system that is loaded first are obtained by the means for exercising overall control that is loaded before the first operating system. Further, since the last operating system that is loaded need not be shifted to the halted state, this operating system is maintained in a post-booted state. That is, in the present invention, after the computer system is activated and after the last loaded operating system has been activated, the normal operation is begun.

The step of halting the operating system that is booted includes the steps of: temporarily shifting the operating system to the halted state if the operating system that is booted has a suspend function, which can store information concerning the operational context of an initial operating system in an operating system memory area that is assigned thereto and which temporarily halts the initial operating system, and a resume function, which shifts the initial operating system to the operating state and which employs the information concerning the operational context of the initial operating system to restore the operational context that existed immediately before the initial operating system was shifted to the temporarily halted state; and independently shutting down the operating system if the operating system does not have the suspend function and the resume function.

According to the present invention, for a computer system in which a plurality of operating systems are mounted and which switches among and employs the operating systems, an operating system mounting method comprises the steps of: booting an operating system having a memory device that has a virtual memory management function for obtaining a predetermined memory area as virtual memory; employing the virtual memory management function of the booted operating system to acquire, as virtual memory, a memory area having a predetermined size in order to use a different operating system; storing, in the memory area that was acquired as the virtual memory, information concerning the operational context of the booted operating system, and temporarily halting the operating system; booting, after the operating system has been temporarily halted, the different operating system in the memory area that was obtained as the virtual memory; halting, after the different operating system has been used, the different operating system and shifting the temporarily halted operating system to the operating state, and employing for the temporarily halted operating system the information concerning the operational context, which was stored in the memory area, in order to recover the operational context that existed immediately before the operating system was temporarily shifted to the halted state.

According to the present invention, for a computer system in which a plurality of operating systems are mounted and which switches among and employs the operating systems, an operating system switching method comprises the steps of: issuing a request for changing from a specific operating system, which is in the operating state, to a different operating system selected from among the plurality of operating systems, which are loaded into corresponding operating system memory areas that are provided by logically dividing a memory area belonging to a memory device; shifting the operating system in the operating state to the halted state; and shifting the different operating system to the operating state, wherein, if the operating system to be switched to the halted state has a suspend function, which stores information concerning the operational context of an initial operating system in a corresponding operating system memory area and temporarily halts the initial operating system, the step of shifting the operating system to the halted state includes the step of employing the suspend function to temporarily shift the operating system to the halted state, wherein, if the different operating system has a resume function, which shifts to the operating state an initial operating system that was temporarily halted by the suspend function and which employs information concerning the operational context of an initial operating system, stored in a corresponding operating system memory area, in order to recover the operational context that existed immediately before the initial operating system was temporarily shifted to the halted state, the step of temporarily shifting the operating system to the halted state includes the step of employing the resume function to shift the different operating system to the operating state.

According to the present invention, for a computer system in which a plurality of operating systems are mounted and which switches among and employs the operating systems, an operating system switching method comprises the steps of: issuing a request for changing from a specific operating system, which is in the operating state, to a different operating system selected from among the plurality of operating systems, which are loaded into corresponding operating system memory areas that are provided by logically dividing a memory area belonging to a memory device; shifting the operating system in the operating state to the halted state; and shifting the different operating system to the operating state, wherein, if the operating system to be switched to the halted state does not have a suspend function, which stores information concerning the operational context of an initial operating system in a corresponding operating system memory area and temporarily halts the initial operating system, the step of shifting the operating system to the halted state includes the step of shutting down the operating system independently to temporarily shift the operating system to the halted state, wherein, if the different operating system does not have a resume function, which shifts to the operating state an initial operating system that was temporarily halted by the suspend function and which employs information concerning the operational context of an initial operating system, stored in a corresponding operating system memory area, in order to recover the operational context that existed immediately before the initial operating system was temporarily shifted to the halted state, the step of temporarily shifting the operating system to the halted state includes the step of rebooting the different operating system to shift the different operating system to the operating state.

With this arrangement, even an operating system that does not have a suspend function and a resume function can coexist with other operating systems.

According to the present invention, a storage medium is provided on which input means for a computer stores a computer-readable program, the computer-readable program permitting the computer to perform: a process for logically dividing a memory area belonging to a memory device to obtain a plurality of operating system memory areas that respectively correspond to a plurality of operating systems; and a process for sequentially loading the operating systems into the corresponding operating system memory areas, the process including a process for employing a boot loader for a specific operating system to boot each of the operating systems in a corresponding operating system memory area, a process for, when there is a different operating system to be loaded, halting the operating system that has been booted, and a process for, after the operating system has been halted, initializing hardware components, other than the memory device and a memory controller, in order to shift program control to a process for loading the different operating system.

With this arrangement, operating systems can coexist in all of the computers that have installed this program.

The process for halting the operating system that is booted includes: a process for temporarily shifting the operating system to the halted state if the operating system that is booted has a suspend function, which stores information concerning the operational context of an initial operating system in an operating system memory area that is assigned thereto and which temporarily halts the initial operating system, and a resume function, which shifts the initial operating system to the operating state and which employs the information concerning the operational context of the initial operating system to restore the operational context that existed immediately before the initial operating system was shifted to the temporarily halted state; and a process for independently shutting down the operating system if the operating system does not have the suspend function and the resume function. With this arrangement, even an operating system that does not have a suspend function and a resume function can coexist with other operating systems.

According to the present invention, a storage medium is provided on which input means for a computer stores a computer-readable program, the computer-readable program permitting the computer to perform: a process for accepting a request to switch from a specific operating system, which is in the operating state, to a different operating system selected from among operating systems that are loaded into corresponding operating system memory areas, which are obtained by logically dividing a memory area belonging to a memory device; a process for, if the operating system to be switched has a suspend function for storing information concerning the operational context of an initial operating system in a corresponding operating system memory area and for temporarily halting the initial operating system, employing the suspend function to shift the specific operating system to the halted state; and a process for, if the different operating system has a resume function for shifting to the operating state an initial operating system that has temporarily been halted by the suspend function and for employing information concerning the operational context of an initial operating system stored in a corresponding operating system memory area in order to recover operational context that existed immediately before the initial operating system was shifted to the temporarily halted state, employing the resume function to shift the different operating system to the operating state.

With this arrangement, for all the computers in which this program is installed, the coexisting operating systems can be quickly switched by using the suspend function and the resume function.

According to the present invention, a program transmission apparatus comprises: storage for storing a program that permits a computer to perform a process for logically dividing a memory area belonging to a memory device to obtain a plurality of operating system memory areas that respectively correspond to a plurality of operating systems, and a process for sequentially loading the operating systems into the corresponding operating system memory areas, the process including a process for employing a boot loader for a specific operating system to boot each of the operating systems in a corresponding operating system memory area, a process for, when there is a different operating system to be loaded, halting the operating system that has been booted, and a process for, after the operating system has been halted, initializing hardware components, other than the memory device and a memory controller, in order to shift program control to a process for loading the different operating system; and a transmitter for reading the program from the storage and for transmitting the program.

With this arrangement, multiple operating systems can coexist on all the computers that download and execute this program.

The process for halting the operating system that is booted includes: a process for temporarily shifting the operating system to the halted state if the operating system that is booted has a suspend function, which stores information concerning the operational context of an initial operating system in an operating system memory area that is assigned thereto and which temporarily halts the initial operating system, and a resume function, which shifts the initial operating system to the operating state and which employs the information concerning the operational context of the initial operating system to restore the operational context that existed immediately before the initial operating system was shifted to the temporarily halted state; and a process for independently shutting down the operating system if the operating system does not have the suspend function and the resume function.

With this arrangement, even an operating system that does not have a suspend function and a resume function can coexist with other operating systems.

According to the present invention, a program transmission apparatus comprises: storage for storing a program that permits a computer to perform a process for accepting a request to switch from a specific operating system, which is in the operating state, to a different operating system selected from among operating systems that are loaded into corresponding operating system memory areas, which are obtained by logically dividing a memory area belonging to a memory device, a process for, if the operating system to be switched has a suspend function for storing information concerning the operational context of an initial operating system in a corresponding operating system memory area and for temporarily halting the initial operating system, employing the suspend function to shift the specific operating system to the halted state, and a process for, if the different operating system has a resume function for shifting to the operating state an initial operating system that has temporarily been halted by the suspend function and for employing information concerning the operational context of an initial operating system stored in a corresponding operating system memory area in order to recover operational context that existed immediately before the initial operating system was shifted to the temporarily halted state, employing the resume function to shift the different operating system to the operating state; and a transmitter for reading the program from the storage and for transmitting the program. With this arrangement, for all the computers that download and execute this program, the coexisting operating systems can be quickly switched by using the suspend function and the resume function.

These and other objects will be apparent to one skilled in the art from the following drawings and detailed description of the invention.

### BRIEF DESCRIPTION OF THE DRAWINGS

FIG. 1 is a diagram illustrating an example arrangement of a memory map that is logically divided in accordance with to the present invention;

FIG. 2 is a conceptual diagram for explaining an image for changing multiple OSs in accordance with the present invention;

FIG. 3 is a diagram for explaining the system configuration of a computer system wherein multiple OSs coexist in accordance with one embodiment of the present invention;

FIG. 4 is a diagram for explaining the arrangement of logical memory blocks in a memory device that is logically divided in accordance with the embodiment;

FIG. 5 is a flowchart for explaining the processing performed to activate the computer system;

FIG. 6 is a diagram for explaining the state shifting for the processing performed in FIG. 5 to activate the computer system;

FIG. 7 is a flowchart for explaining the processing performed to change OSs;

FIG. 8 is a diagram for explaining the state shifting in the OS switching processing performed in FIG. 7;

FIG. 9 is a flowchart for explaining the processing performed to terminate the system;

FIG. 10 is a diagram for explaining another arrangement of the logical memory blocks in the memory device that is logically divided in accordance with the embodiment;

FIG. 11 is a flowchart for explaining other processing performed to activate the computer system in accordance with the embodiment;

FIG. 12 is a diagram for explaining the state shifting for the processing performed in FIG. 11 to activate the computer system;

FIG. 13 is a flowchart for explaining the OS switching processing;

FIG. 14 is a diagram for explaining the state shifting for the OS switching processing performed in FIG. 13;

FIG. 15 is a diagram showing an additional example arrangement for the memory map that is logically divided in accordance with the present invention;

FIG. 16 is a diagram for explaining the system configuration of a computer system wherein multiple OSs coexist in accordance with another embodiment of the present invention;

FIG. 17 is a diagram for explaining the arrangement of logical memory blocks in a memory device that is logically divided in accordance with the embodiment;

FIG. 18 is a diagram for explaining the processing whereby a virtual memory acquisition and management unit in this embodiment requests that an OS memory manager obtain virtual memory;

FIG. 19 is a flowchart for explaining the processing performed by the virtual memory acquisition and management unit to obtain the virtual memory; and

FIG. 20 is a diagram for explaining the suspend operation and the resume operation.

### DESCRIPTION OF THE PREFERRED EMBODIMENT

The present invention will now be described in detail during the course of an explanation presented for the preferred embodiment, given while referring to the accompanying drawings. First, an overview of the present invention will be given. According to the present invention, a memory area is logically divided into logical memory blocks, and operating systems (OSs) are assigned to the individual blocks, thus enabling multiple operating systems to coexist in a single computer system.

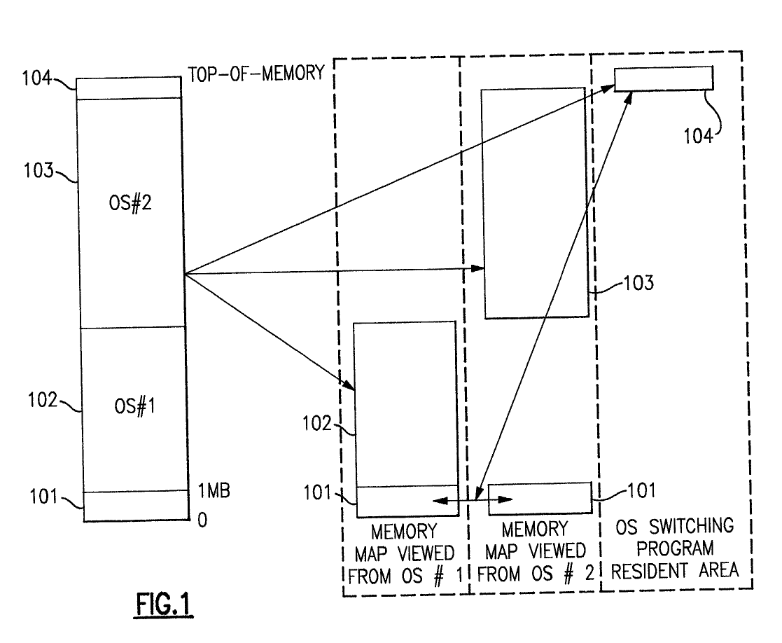

FIG. 1 is a diagram showing an example structure for a memory map, which is logically divided in accordance with the invention, wherein there are two coexisting OSs, OS#1 and OS#2. In FIG. 1, a memory is logically divided into a memory area 101 of 0 to 1 MB, which is consistently used by each OS, memory areas 102 and 103, which are assigned to the individual OSs, and an independent memory area 104, which is used for switching OSs. Each OS identifies its locally assigned memory area as constituting all of the memory available in the computer system. That is, as is shown in FIG. 1, the memory map as viewed from OS#1 covers a range that includes memory areas 101 and 102, and the memory map as viewed from OS#2 covers a range that includes memory areas 101 and 103. In FIG. 1, of the total memory available, the space allocated for memory area 101 is 0 to 1 MB, but different sizes or different locations can be established, depending on the coexisting OSs. Further, if an area that is not consistently used by coexisting OSs is present and no memory area conflict occurs, the memory area 101 need not be provided.

According to the present invention, in principle, OSs are switched by using the suspend function and the resume function that are supported by each OS. That is, while one specific OS is being run, the other OS is suspended and is temporarily halted. Then, when the OS is changed from one to the other, the OS that is currently being used is suspended, and by using the resume function, the next OS is recovered to the state it occupied immediately before it was suspended.

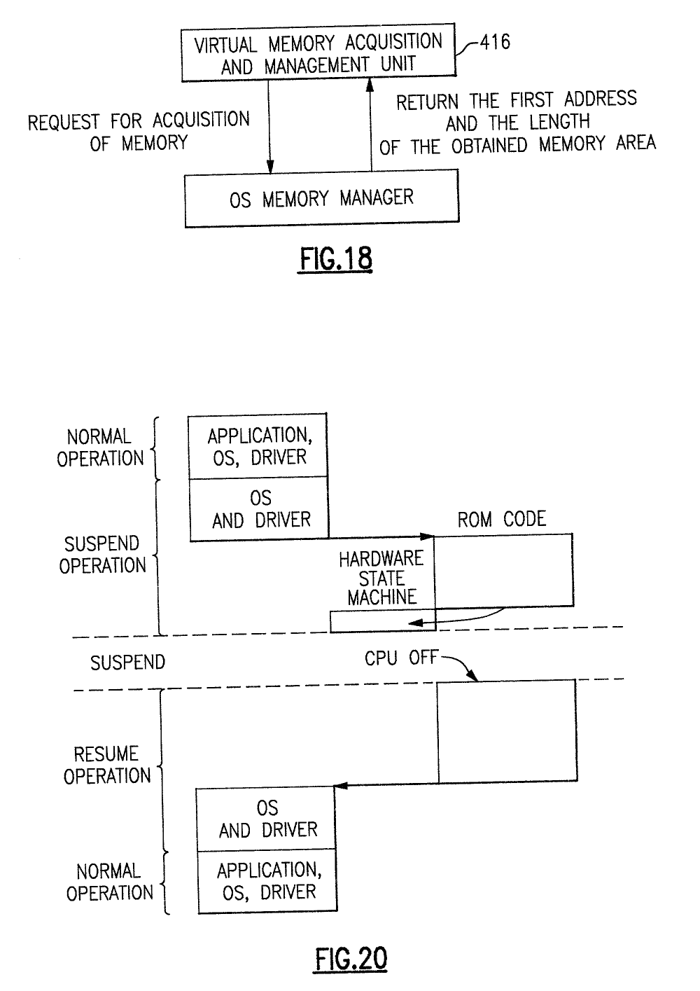

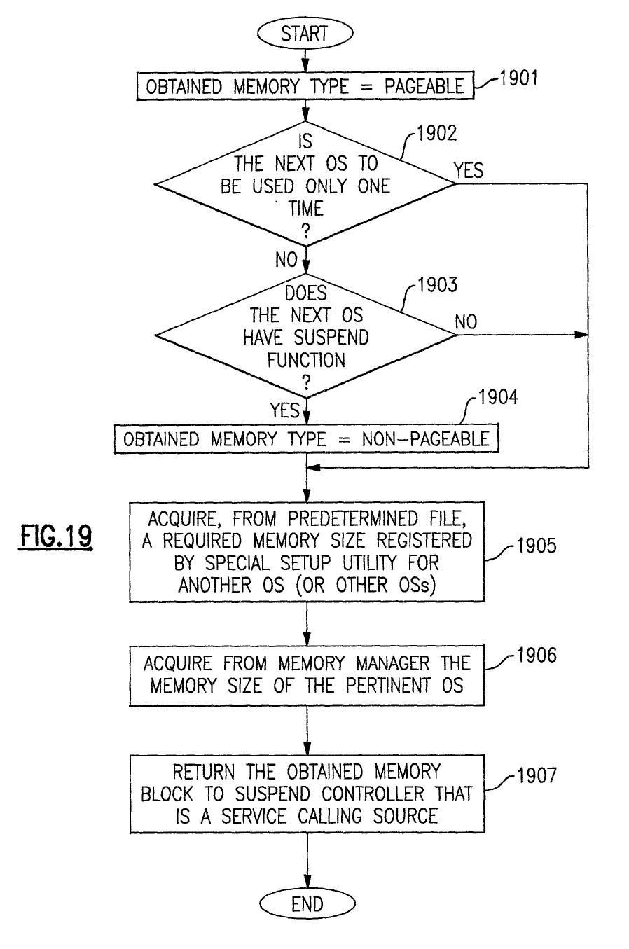

FIG. 20 is a diagram for explaining the suspend and the resume functions. In FIG. 20, in the course of the normal operation of a computer system, an application program, an OS and a device drivers are being run. Then, when a suspend event occurs and the suspend event is initiated, first, the execution right of the application program is lost and a message that the suspend event has occurred is transmitted to the application program by the OS. Also at this time, the device drivers are notified that the suspend event has occurred and are temporarily halted, and the internal data are stored or abandoned, as appropriate. Following this, the ROM BIOS is called.

In the ROM BIOS, data stored in a cache are mirrored in the memory using cache flashing, and the contexts of a CPU register and of the basic motherboard devices are stored. Subsequently, the system memory is changed to a low power consumption mode and is electrically isolated from the outside, and the hardware state machine is activated and automatically disconnects a power source. The state thus assumed is called a suspended state.

Then, when a resume event occurs, power is again supplied to the devices that were disconnected, and the ROM BIOS, which is activated from the CPU reset state as it is when a normal power on event occurs, confirms the occurrence of the resume operation by using a predetermined hardware flag to which power is continuously supplied, even in the suspended state, and returns the system memory to the normal mode to permit a normal access. Thereafter, the cache is initialized, the context of the basic motherboard device is restored or re-initialized, and the CPU register is recovered.

Next, the time information is recovered and the device drivers are notified. Drivers that operate physical devices initiate the operation by regarding the previous device context as lost, and the physical devices are initialized, as needed. A recovery message is then transmitted to the application program.

The application program, which lost the execution right as a result of the occurrence of the suspend event, regains the execution right and resumes its operation at the point at which the execution right was lost. Thus, the computer system is returned to the normal operating state.

According to the present invention, the suspend process and the resume process are performed for each of the OSs that are loaded in the memory areas. While the CPU is not operated in a normal suspended state, in this invention the CPU remains active, continuously. Specifically, in the invention, immediately before the CPU is halted when a specific OS performs a normal suspend process, the execution right is shifted to a module that is in charge of changing from the specific OS to another OS that is loaded in the independent memory area. Therefore, the CPU is constantly active. In this process, the execution right of the CPU is shifted from a currently used OS to the next OS that is to be used.

That is, at a specific time, a predetermined OS is in the normal operating state while another OS is in the suspended state. When the OS in the normal operating state is shifted to the suspended state, another OS is recovered and returned to the normal operating state by the resume process, so that the OS that is to be used is changed. As is described above, in this invention, the OSs in the memory areas are independent, and when the OSs are switched, the control right is shifted across the boundaries of the memory areas.

FIG. 2 is a conceptual diagram for explaining an image for switching multiple OSs according to the present invention. In FIG. 2, first, ROM code is booted to load the OS#1 to the memory areas 101 and 102, and to load OS#2 into the memory areas 101 and 103. At this time, since the memory area 101 is used by the two OSs #1 and #2, a conflict occurs. Thus, the contents in the memory area 101 for the OS that is not currently being used are retracted to the independent memory area 104. Thereafter, OS#1 and OS#2 are present in their individually allocated memory areas, and the active OS is changed by the suspend and the resume functions. Since the suspend and resume processes are used to switch the OSs, a quick OS change operation is available. Further, since a recovered OS resumes the operating state (context) at a point immediately before it was suspended, there is a considerable improvement in user convenience.

Instead of the independent memory area 104, a retraction storage area 105 that is prepared in a secondary storage device may be employed as the area to which the data in the memory area 101 is retracted. The storage area 105 may be prepared for each OS in the partition of the secondary storage device wherein the individual OSs are stored (in FIG. 2, the area 105 is provided for each OS), or may be provided as a special partition that does not belong to any OS in the secondary storage device. Preparing the storage area 105 as a special area is efficient, since the storage area 105 need not be prepared for each OS.

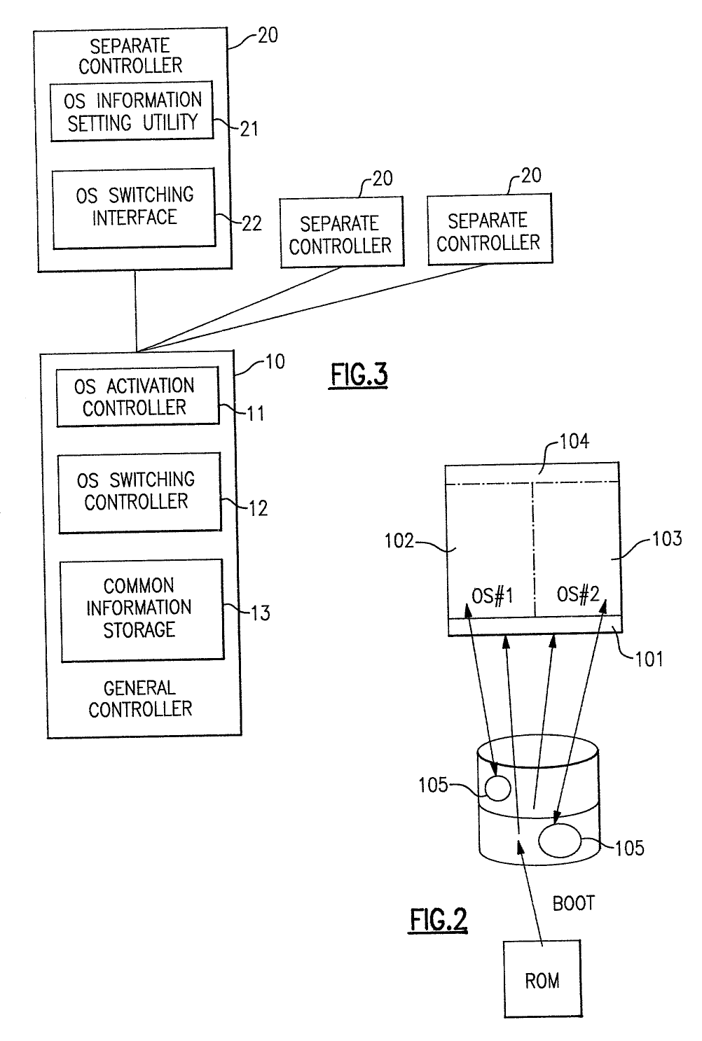

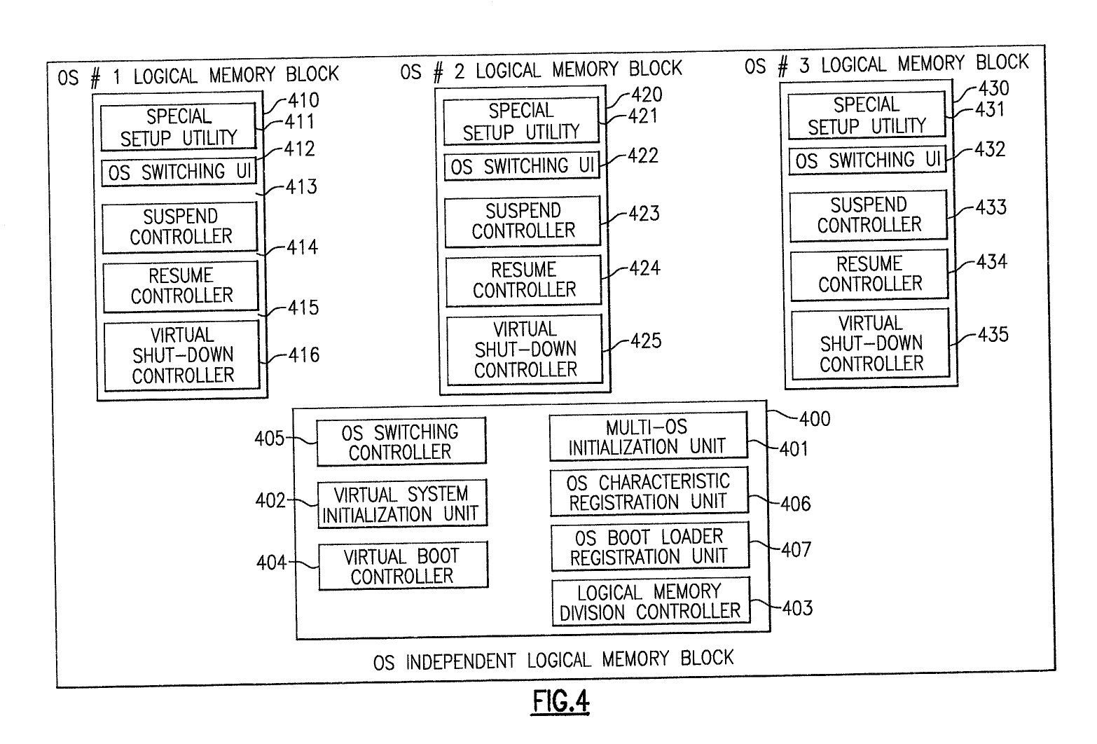

FIG. 3 is a diagram for explaining the system configuration of a computer system according to the present invention wherein multiple OSs coexist. In FIG. 3, the computer system in this embodiment comprises: a general controller 10 for the overall control of multiple OSs that coexist in the system; and separate controllers 20 that are prepared for individual OSs. The general controller 10 employs the memory area (e.g., the independent memory area 104 in FIGS. 1 and 2) that is provided independent of the OSs to control the OSs, and the separate controllers 20 employ the memories allocated for the OSs to control the respective OSs.

The general controller 10 comprises: an OS activation controller 11, for controlling the activation of the OSs when the system is activated; OS switching controller 12, for switching OSs at run time; and common information storage 13, for collectively storing information that should be used in common by the OSs, such as information concerning other OSs that is required when the OSs are activated or changed.

Each of the separate controllers 20 comprises: OS information setting utility 21, for setting information concerning the individual OS that is required to permit multiple OSs to coexist; and OS switching interface 22, for providing a user interface so that a user can instruct the switching of the OS at run time. If OSs that coexist are consistently determined in advance, and information concerning these OSs is stored in the common information storage 13 of the general controller 10, the OS information setting utility 21 need not always be provided.

The OS activation controller 11 sequentially activates coexisting OSs when the system is activated. At this time, the position and the size of the memory area required to load each OS are determined by referring to the information stored in the common information storage 13. To activate the second, and succeeding OSs, as will be described later, the suspend function of the OS is employed to halt the OS that has been activated, and the system is initialized to activate the next OS. Therefore, immediately after the activation of all the coexisting OSs has been completed, the last activated OS is in the operating state, and all the other OSs that were activated before it are in the halted state. Specific processing that is used to activate multiple OSs will be described later.

The OS switching controller 12 changes an OS that is to be used at run time. Specifically, the OS switching controller 12 receives information concerning the next OS from the OS switching interface 22 of the separate controller 20 for the currently operation OS. When the currently operating OS is shifted to the halted state by the suspend function, based on the received information the OS switching controller 12 shifts the next OS to the operating state. As means for shifting the OS in the halted state to the operating state, the resume function prepared for the OS can be employed, or a virtual boot process can be performed. These processes will be specifically explained later.

The common information storage 13 is used to store, for the activation and the switching of OSs, information such as the position and the size of a memory area to be used to load each coexisting OS, the minimum required memory size required for the operation of each OS, the address of the boot loader in the secondary storage device that is used for activating each OS, the means for shifting each OS to the halted state or to the operating state, the starting physical address and the length of the memory area required for the operation, and, as needed, the starting address of a retraction area that is obtained in the secondary storage device to retract the data in the memory area that is repetitively employed. These data are designated by the OS information setting utility 21 of the separate controller 20 provided for each OS. It should be noted that for execution the general controller 10, including the common information storage 13, employs the memory area provided independent of the individual OSs; however, the data stored in the common information storage 13 may be stored in the pertinent independent memory area, or may be stored as one of the OSs' files with the stipulation that the information can be accessed by all the OSs.

The OS information setting utility 21 is operated by a corresponding OS, and establishes the information concerning the corresponding OS, i.e., information, used for the activation and the switching of OSs, such as the position and the size of the memory area for loading the OS, the minimum memory size required for operating the OS, the address of the boot loader in the secondary storage device for activating the OS, the means for shifting the OS from the halted state or the operating state, the starting physical address and the length of the memory area required for operation, and, as needed, the starting address of the retraction area that is obtained in the secondary storage device for retracting data from the memory area that is repetitively employed. Information concerning which OS should be activated after the pertinent OS is also designated.

The OS switching interface 22, which is operated by a corresponding OS, accepts entries by a user, designates the OS that is to be used next and initiates an OS switching operation. When the OS switching is begun, the currently operating OS is shifted to the halted state using the suspend function. The OS switching operation will be specifically described later.

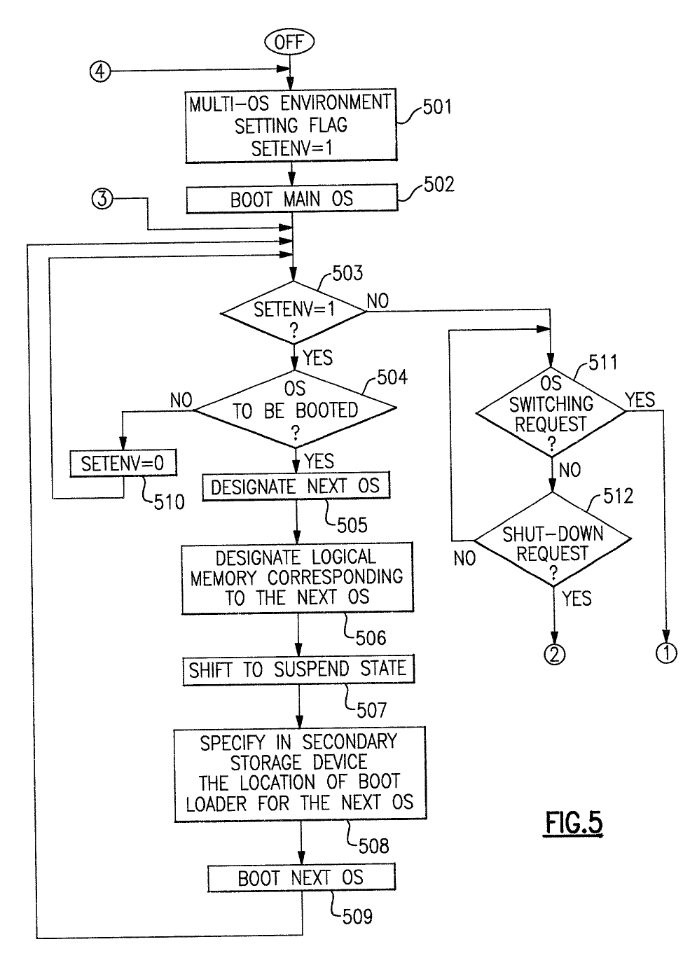

FIG. 4 is a diagram for explaining the arrangement of logical memory blocks in a memory device that is logically divided in accordance with the embodiment. Since three OSs, OS#1, OS#2 and OS#3, coexist in the memory device in FIG. 4, the memory device includes an OS#1 logical memory block 410, an OS#2 logical memory block 420, an OS#3 logical memory block 430 and a logical memory block 400, independent of the OSs. In addition, although not shown, the memory device includes a logical memory block used in common by OS#1, OS#2 and OS#3. It should be noted that when of OS#1, OS#2 and OS#3 one is in the operating state, the logical memory block used in common is employed as the logical memory block for the currently operating OS. In this embodiment, each of the coexisting OSs, OS#1, OS#2 and OS#3, have both the suspend function and the resume function.

In FIG. 4, in the independent logical memory block 400, a multi-OS initialization unit 401, a virtual system initialization unit 402, a logical memory division controller 403 and a virtual boot controller 404 are loaded as function execution units corresponding to the OS activation controller 11 of the general controller 10. Furthermore, an OS switching controller 405 is loaded as a function execution unit that corresponds to the OS switching controller 12, and an OS characteristic registration unit 406 and an OS boot loader registration unit 407 are loaded as execution function units that correspond to the common information storage 13.

The multi-OS initialization unit 401 sequentially boots and runs the individual OSs when the system is activated. Before an OS is run by the multi-OS initialization unit 401, the virtual system initialization unit 402 initializes all the hardware components, except for the memory and the memory controller. The hardware components are initialized because each OS recognizes that the entire system has been initialized when the first OS is run. The state wherein all hardware components other than the memory and the memory controller have been initialized is called a virtually initialized state.

The logical memory division controller 403 stores information concerning the positions and the sizes of the independent logical memory block 400, the OS#1 logical memory block 410, the OS#2 logical memory block 420 and the OS#3 logical memory block 430. When one or more OSs have already been booted and another OS is to be booted, the virtual boot controller 404 accesses the boot loader of the OS that is stored in the secondary storage device and is to be booted next. The virtual boot controller 404 then loads the pertinent boot loader into the logical memory block allocated for the OS.

If there is a memory area wherein two OSs conflict, the OS switching controller 405 retracts the contents of the memory area for the currently operating OS to prevent a conflict during the run time changing of the OSs. The OS switching controller 405 then shifts to the operating state the next OS that is to be activated.

The OS characteristic registration unit 406 stores the information inherent to an OS, such as the minimum required memory size for the operation of the OS, information concerning the physical memory area that is required for the operation, and information concerning whether the suspend function should be employed to shift the OS to the halted state in order to switch the OSs. The OS boot loader registration unit 407 stores the addresses of the boot loaders for the individual OSs in the secondary storage device.

In the OS#1 logical memory block 410, the OS#2 logical memory block 420 and the OS#3 logical memory block 430, special setup utilities 411, 421 and 431 are loaded as function execution units corresponding to the OS information setting utility 21 of the separate controllers 20. Furthermore, OS switching user interfaces (UIs) 412, 422 and 432 are loaded as the function execution units corresponding to the OS switching interface 22. In addition, since the suspend function and the resume function that are supported by each OS are employed to change the OS to the halted state or to the operating state, suspend controllers 413, 423 and 433 and resume controllers 414, 424 and 434 are loaded. In addition, virtual shut-down controllers 415, 425 and 435 are loaded, so that the individual OSs can be separately terminated, while overall the system continues to operate. In this embodiment, the virtual shut-down controllers 415, 425 and 435 are not requisite components, and may not be provided if the individual OSs do not need to be terminated separately.

The special setup utilities 411, 421 and 431 designate, for the activation and the switching of the OSs, information such as the position and the size of the memory area required to load each coexisting OS, the minimum required memory size for operating each OS, the address in the secondary storage device of a boot loader for activating each OS, the means for shifting each OS to the halted state or to the operating state, the starting physical address and the length of a memory area required for operation, and, as needed, the starting address of the retraction area that is obtained in the secondary storage device for retracting the memory area that is repetitively employed. These data are registered in the logical memory division controller 403, the OS characteristic registration unit 406 and the OS boot loader registration unit 407.

The OS switching user interfaces (UIs) 412, 422 and 432 designate a destination OS and initiate the switching operation in order to perform an OS run time change. An arbitrary user interface type, such as a graphical user interface or a character-based user interface, can be established in accordance with the format of the OS. And a simple user interface may also be employed. For example, upon the receipt of a notification that a state change for a special button has been detected by a device driver, the current OS is changed to the one that corresponds to the current state of the button, or upon the receipt of a signal produced by the depression of a shortcut key on a keyboard, the current OS is changed to a corresponding OS. The suspend controllers 413, 423 and 433 and the resume controllers 414, 424 and 434 are implemented by the general suspend function and the resume function that the OSs support. As is described above, in an active system, the virtual shut-down controllers 415, 425 and 435 independently terminate only the initial OSs. During actual operation, whether the termination of a currently operating OS signals the shutting down of the entire system or of only the pertinent OS is selected, and when only the termination of the OS is selected, one of the virtual shut-down controllers 415, 425 and 435 terminates the relevant, individual OS. As is described above, the virtual shut-down controllers 415, 425 and 435 are not requisite components, but when they are present, instead of having to use the suspend function and the resume function, the termination of an individual OS by one of the virtual shut-down controllers 415, 425 and 435 can be employed to change to the next OS. The processing required to do this will be described later.

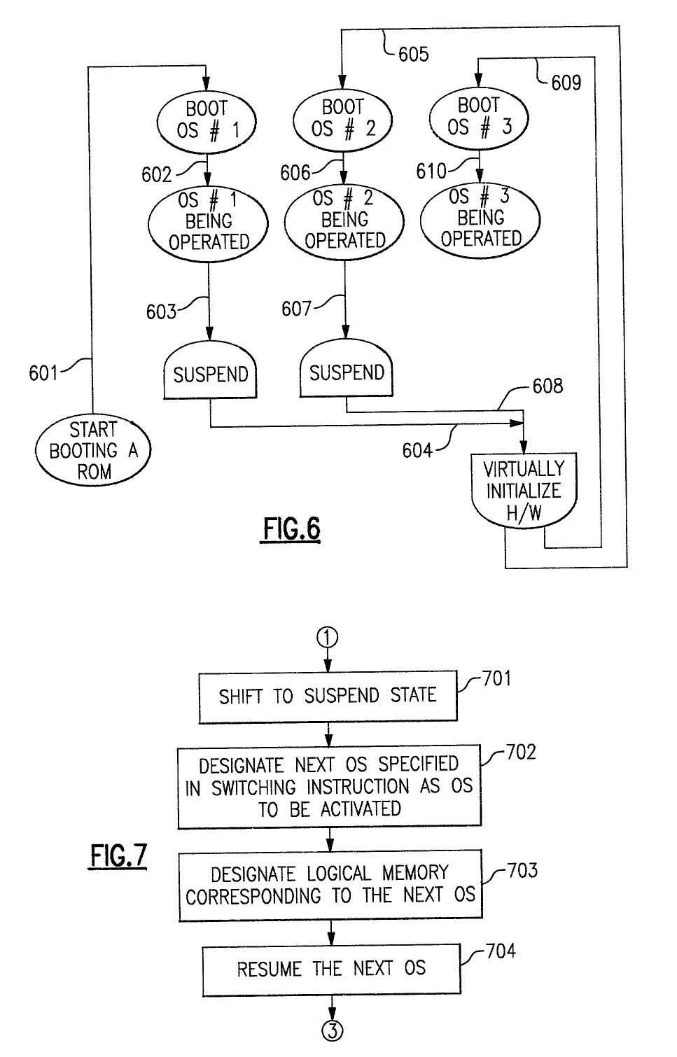

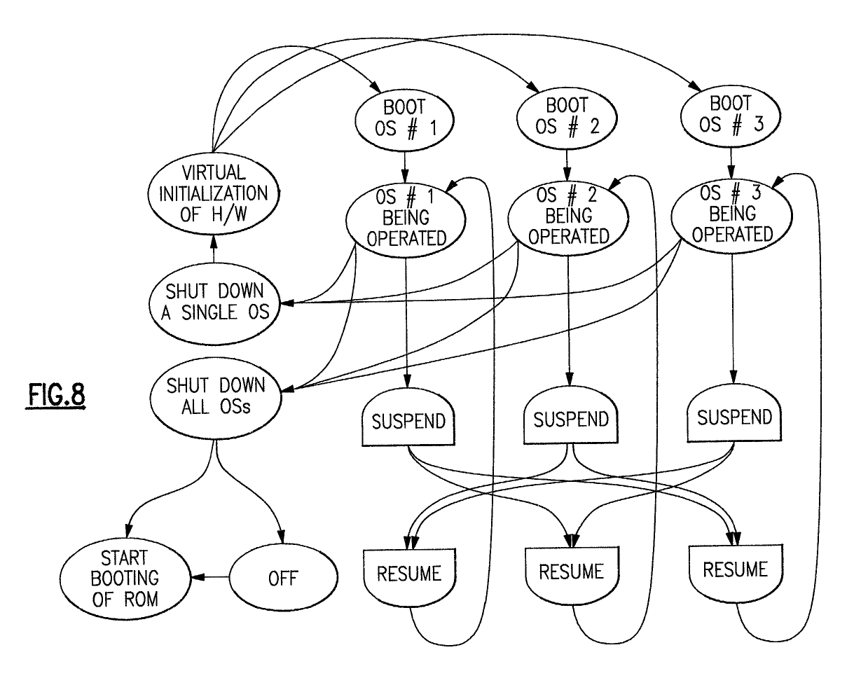

An explanation will now be given for the processing performed to activate a computer system wherein OS#1, OS#2 and OS#3 coexist. FIG. 5 is a flowchart for explaining the processing performed to activate the computer system, and FIG. 6 is a diagram for explaining the state shifting performed when the computer system is activated.

In this embodiment, multiple OSs can coexist by loading into the independent logical memory block 400 of the memory device the multi-OS initialization unit 401, the virtual system initialization unit 402, the logical memory division controller 403, the virtual boot controller 404, the OS switching controller 405, the OS characteristic registration unit 406, and the OS boot loader registration unit 407. Therefore, during the first operation sequence for activation of the system, these function execution units must be loaded into the independent logical memory block 400. Various methods can be employed for loading these function execution units, and in this embodiment, an explanation will be given for a method for loading these units into the independent logical memory block 400, along with a specific OS, and a method for loading these units before loading the OS.

First, an explanation will be given for a method for loading the function execution units, along with a specific OS, into the independent logical memory block 400. According to this method, the first OS that is to be booted (hereinafter referred to as a main OS) is specified when the system is activated, and programs for the multi-OS initialization unit 401, the virtual system initialization unit 402, the logical memory division controller 403, the virtual boot controller 404, the OS switching controller 405, and the OS characteristic registration unit 406 and the OS boot loader registration unit 407 are stored as files associated with the specified OS. When the pertinent OS is booted, these function execution units are loaded together. In this case, the activation of the second and the following OSs, including the management of their memory areas, is performed by the multi-OS initialization unit 401, the virtual system initialization unit 402, the logical memory division controller 403, the virtual boot controller 404, the OS switching controller 405, the OS characteristic registration unit 406 and the OS boot loader registration unit 407. Therefore, the memory areas allocated for the second and the following OSs that are to be activated need not correspond to the configuration for the coexistence of the OSs according to the embodiment. However, since the main OS is activated before the multi-OS initialization unit 401, the virtual system initialization unit 402 and the logical memory division controller 403 are loaded into the independent logical memory block 400, the main OS must recognize the allocated memory area and the processing performed to shift the right of control to the multi-OS initialization unit 401 after the main OS has been activated, and for shifting the main OS to the halted state.

The processing performed when the system is activated will now be explained while referring to FIGS. 5 and 6. In this embodiment, OS#1 is first activated as the main OS. In the schematic flowchart in FIG. 5 showing the processing performed when the system is activated, when the main OS is booted (steps 501 and 502), a check is performed to determine whether there is another OS to be booted (steps 503 and 504). If there are other OSs, an OS to be booted next is designated (step 505), and a logical memory block for loading the OS is designated (step 506). Then, the OS that is currently running is suspended (step 507), and the location in the secondary storage device, whereat the boot loader of the next OS is stored, is specified (step 508) and the booting is initiated (step 509). Thereafter, the process from step 503 to step 509 is repeated until all the coexisting OSs in the system have been booted. When all the coexisting OSs in the system have been booted, the currently operating OS continues to run until a request is issued to change from the pertinent OS to another OS, or until an end command is issued (steps 510, 511 and 512).

This processing will be specifically explained while referring to the state shifting diagram in FIG. 6. First, when the system is powered on and the booting of the ROM is initiated, the ROM code loads an MBR (Master Boot Record) to begin the booting of the main OS, OS#1 (see 601). As is described above, since the main OS, OS#1, recognizes the memory area allocated for OS#1, OS#1 is automatically loaded to the pertinent memory area (the OS#1 logical memory block 410 in FIG. 4).

Then, when OS#1 is activated, as is described above, the programs for the multi-OS initialization unit 401, the virtual system initialization unit 402, the logical memory division controller 403, the virtual boot controller 404, the OS switching controller 405, the OS characteristic registration unit 406 and the OS boot loader registration unit 407, all of which are stored as OS#1 files, are loaded into the independent logical memory block 400. Therefore, the activation of OS#2 and OS#3 is controlled by the multi-OS initialization unit 401, the virtual system initialization unit 402, the logical memory division controller 403, the virtual boot controller 404, the OS switching controller 405, the OS characteristic registration unit 406, and the OS boot loader registration unit 407.

When OS#1 has been booted and is set in the operating state, the right of execution is shifted to the multi-OS initialization unit 401 in order to activate another OS, and the suspend controller 413 employs the OS#1 suspend function to temporarily shift OS#1 to the halted state (see 602 and 603).

First, before the operating environment for OS#2 is set, the multi-OS initialization unit 401 queries the OS switching controller 405 to determine whether there is physical memory (the memory area 101 in FIGS. 1 and 2) that is also used by OS#1. Since during the initialization process the OS switching controller 405 has already obtained, from the OS characteristic registration unit 406, information concerning the physical memory area required for all the coexisting OSs, the OS switching controller 405 retracts the contents (one part of the program for OS#1) stored in the repetitively used area to the independent logical memory block 400. The size of the data to be retracted is determined in accordance with the individual types of coexisting OSs. Accordingly, the memory size of the independent logical memory block 400 is flexibly set in accordance with the coexisting OSs. And as previously explained, information, such the size of the data to be retracted and the location of a conflict in physical memory, is stored in advance in the OS characteristic registration unit 406.

In the above operation, the destination whereat the contents of the physical memory wherein a conflict exists are to be retracted is designated as the independent logical memory block 400. However, instead of the independent logical memory block 400, the retraction storage area provided in the secondary storage device shown in FIG. 2 may be employed. While as described above, the destination for the contents retracted from the physical memory can be either the independent logical memory block 400 or the storage area in the secondary storage device, in the following explanation the contents are retracted to the independent logical memory block 400.

The multi-OS initialization unit 401 permits the virtual system initialization unit 402 to initialize the hardware components, and the virtual system initialization unit 402 initializes all the hardware components, other than the memory and the memory controller, in the same manner as the ROM code initializes the hardware by rebooting. Thus, the same initial hardware condition is obtained when OS#2 is booted. The state wherein the booting of OS#2 can be started while another OS already exists in the memory is called the virtual system initialized state (see 604).

The multi-OS initialization unit 401 obtains, from the OS boot loader registration unit 407, the address in the secondary storage device whereat the boot loader of the second OS, OS#2, to be activated is stored. The right of execution is shifted to the virtual boot controller 404, and the partition at the pertinent address is accessed and the boot loader is developed in the memory. Then, the right of execution is shifted to the boot loader (see 605 and 606). At this time, the OS#2 logical memory block 420 is used as the main memory, and when OS#2 is booted it identifies the pertinent memory area as constituting the total of the memory in the system.

Generally, if the memory size or the memory address of the pertinent machine is discontinuous, the OS must know the entire memory map in order to identify and locate the memory hole. Normally, the OS obtains information concerning the memory through a service provided by a specific ROM BIOS, and uses the memory in accordance with the state for the received physical memory. Therefore, only if the memory information provided when each OS is activated is replaced with the memory information obtained when the multi-OS initialization unit 401 logically and intentionally divides the memory area, can the OS that obtains the memory information identify the logically divided memory block as the entire effective memory of the machine.

Similarly, in the operating state OS#2 is temporarily shifted to the halted state by the suspend controller 423 using the OS#2 suspend function, and the right of execution is shifted to the multi-OS initialization unit 401 to activate another OS (see 607 and 608). Then, the contention memory area is detected, the contents (one part of the program for OS#2) are retracted to the independent logical memory block 400, and the hardware is set to the virtual system initialized state (see 608). Thereafter, the boot loader for OS#3 is developed in the OS#3 logical memory block 430, and the right of execution is shifted (see 609). Thus, the third OS, OS#3, is set in the operating state (see 610).

Through the above operation, activation of all three OSs, OS#1, OS#2 and OS#3, is completed, and the multi-OS operating environment is constructed. At this time, OS#1 and OS#2, which were activated first, are temporarily placed in the halted state using the suspend function, and the last activated OS, OS#3, is in the operating state.

An explanation will now be given for the method used to load the function execution units into the independent logical memory block 400 before all the OSs are loaded. According to this method, the multi-OS initialization unit 401, the virtual system initialization unit 402, the logical memory division controller 403, the virtual boot controller 404, the OS switching controller 405, the OS characteristic registration unit 406 and the OS boot loader registration unit 407 form a program package that is to be loaded into the independent logical memory block 400. This program package is regarded as an independent OS, and is booted before all the other coexisting OSs. Therefore, a special partition is independently prepared in the secondary storage device.

In this case, all the OSs correspond to the second and following OSs that are booted using the above method in accordance with which the OSs are loaded into the independent logical memory block 400 when the main OS is booted. Therefore, an OS, such as the main OS, need not be provided that identifies the locally allocated memory area and performs the processing for transmitting the right of control to the multi-OS initialization unit 401 after the local OS is activated, and for shifting the local OS to the halted state.

The processing performed when the system is activated is the same as that performed when the main OS is set and activated, except for booting, at step 501 and 502, not the main OS but the program package that includes the multi-OS initialization unit 401, the virtual system initialization unit 402, the logical memory division controller 403, the virtual boot controller 404, the OS switching controller 405, the OS characteristic registration unit 406 and the OS boot loader registration unit 407. Further, in FIG. 6, since the program package that includes the multi-OS initialization unit 401, the virtual system initialization unit 402, the logical memory division controller 403, the virtual boot controller 404, the OS switching controller 405, the OS characteristic registration unit 406 and the OS boot loader registration unit 407 is booted before OS#1 is booted, the loading of the program into the independent logical memory block 400 is terminated when the booting of the ROM has been initiated. The system is then set to the virtual system initialized state, and thereafter, OS#1, OS#2 and OS#3 are booted in the named order. Since the state shifting when the individual OSs are booted is the same as when OS#1 is activated as the main OS, no further explanation will be given.

The processing for the run time switching of the OSs will now be explained. FIG. 7 is a flowchart for explaining the OS switching processing, and FIG. 8 is a diagram for explaining the state shifting when the OS is changed.

In the flowchart in FIG. 5, when at step 511 a request for switching from a predetermined OS to another is issued by the OS switching user interface 412, 422 or 432 of the predetermined OS, program control shifts to the processing in FIG. 7. The separate controller 20 suspends the currently operating OS (step 701), and the general controller 10 defines the OS that is designated in the switching request as the next OS that is to be activated (step 702), and designates the corresponding logical memory block (step 703). Then, the resume controller 414, 424 or 434 of the designated OS is employed to shift the next OS to the operating state (step 704).

When there is physical memory wherein a conflict occurs when the OS is changed, the contents of the memory are retracted to the independent logical memory block 400 or to the storage area of the secondary storage device. For this processing, the contents of the physical memory are retracted to the independent logical memory block 400.

The processing will be explained while referring to the block diagram in FIG. 4 and the state shifting diagram in FIG. 8. First, assume that OS#3 is currently operating. This is the same condition as exists immediately after the multi-OS operating environment has been constructed. In this state, assume that a user employs the user interface 432 to request a change from OS#3 to OS#1. Then, the right of execution is shifted to the suspend controller 433 of OS#3, and OS#3 is shifted to the suspended state. Following this, the right of execution is shifted to the general controller 10, and the OS that is designated as the switching destination by the OS switching user interface 432 is transmitted to the OS switching controller 405 of the independent logical memory block 400.

When the hardware context of the system is stored through the suspend process, the OS switching controller 405 shifts the right of execution to the resume controller 414 for OS#1 in order to shift OS#1 to the resumed state. The resume controller 414 recovers the hardware context to the state that existed when OS#1 was suspended. The memory context for OS#1 while it was suspended was continuously stored during the OS#3 operating time. Therefore, when the hardware context is recovered, and when the operation is resumed immediately following the last address at which OS#1 was shifted to the suspended state, OS#1 can be restarted in the same manner as when it is resumed from a simple suspended state. After OS#1 has recovered to the operating state, it adjusts the time information for the resume process, or if OS#1 was connected to a network before it was suspended, the network link is recovered to the previous connected state.

As is described above, since the OS can be switched by using the suspend function and the resume function, without rebooting the OS, the OSs can be changed extremely quickly.

The processing performed when the system is terminated will now be described. As is described above, when the virtual shut-down controllers 415, 425 and 435 are respectively loaded into the OS#1 logical memory block 410, the OS#2 logical memory block 420 and the OS#3 logical memory block 430, whether only the currently operating OS or the entire system should be terminated can be selected when the OS is to be terminated.

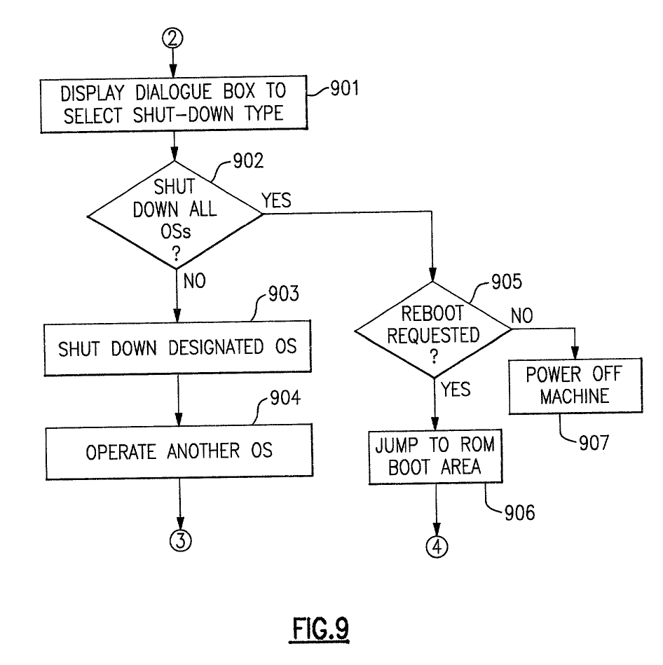

FIG. 9 is a flowchart for explaining this processing. In the flowchart in FIG. 5, when at step 512 the request for terminating the currently operating OS is issued, program control shifts to the processing in FIG. 9. A dialogue box is displayed to permit a user to select the termination type (the termination of only the pertinent OS or of the entire system) (step 901). When the user selects the termination of only the currently operated OS, the pertinent OS is terminated (steps 902 and 903), and another OS is shifted to the operating state (step 904). The OS to be shifted to the operating state may be selected during the end process or may be determined in advance. When the OS is designated in advance, a specific OS may be shifted to the operating state, or the next OS to be set to the operating state may be determined in accordance with the OS that is to be terminated. For example, when OS#1 is terminated, OS#2 is shifted to the operating state, when the OS#2 is terminated, OS#3 is shifted to the operating state, or when OS#3 is terminated, OS#1 is shifted to the operating state.

When the termination of the entire system is selected and a request is received for a reboot, program control jumps to the boot entry for the ROM, and the entire system is re-activated (steps 905 and 906). But when a reboot is not requested, the computer is powered off (steps 905 and 907).

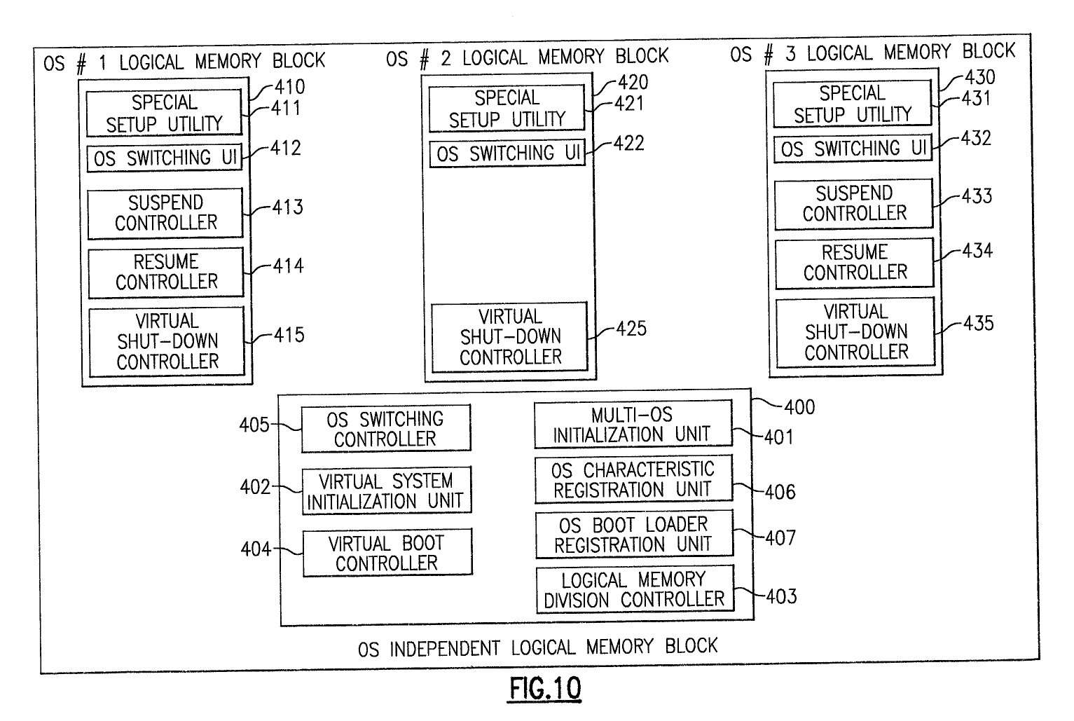

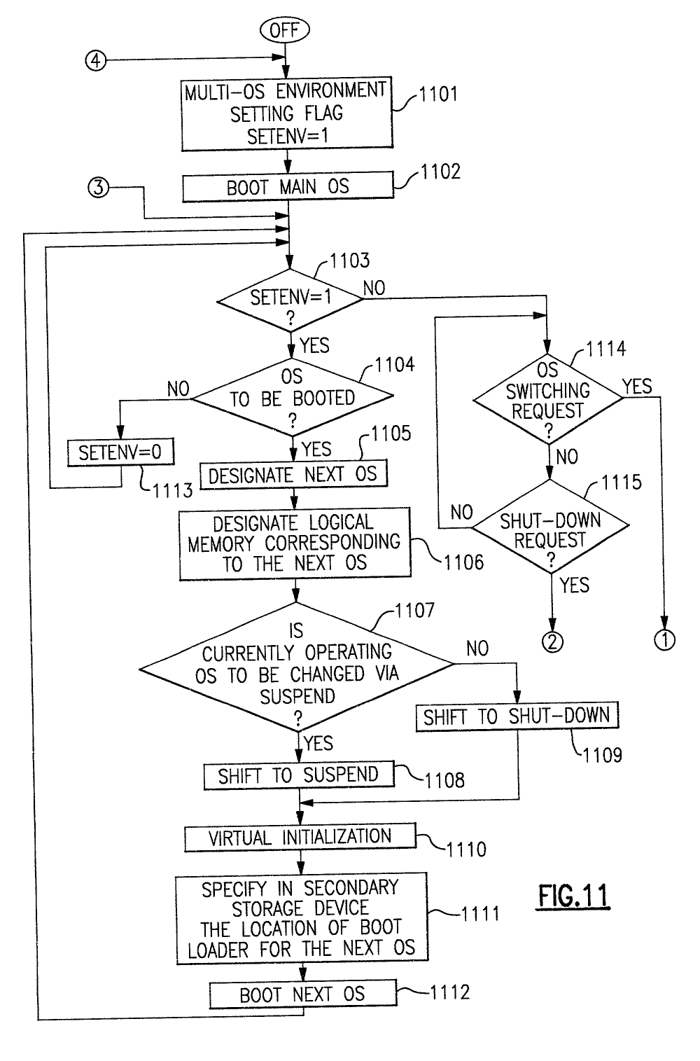

FIG. 10 is a diagram showing another arrangement for the logical memory blocks obtained by the logical division performed by the memory device according to the embodiment. The memory device in FIG. 10, as in FIG. 4, includes an OS#1 logical memory block 410, an OS#2 logical memory block 420, an OS#3 logical memory block 430 and an independent logical memory block 400, and three coexisting OSs, OS#1, OS#2 and OS#3. Further, although not shown, a logical memory block that is used in common by OS#1, OS#2 and OS#3 is also included. In this instance, OS#2 does not include the suspend function and the resume function.

In FIG. 10, in the independent logical memory block 400, a multi-OS initialization unit 401, a virtual system initialization unit 402, a logical memory division controller 403 and a virtual boot controller 404 are loaded as function execution units that correspond to the OS activation controller 11 of the general controller 10. Further, an OS switching controller 405 is loaded as the function execution unit that corresponds to the OS switching controller 12, and an OS characteristic registration unit 406 and an OS boot loader registration unit 407 are loaded as the function execution units that correspond to the common information storage 13.

In addition, in the OS#1 logical memory block 410, the OS#2 logical memory block 420 and the OS#3 logical memory block 430, special setup utilities 411, 421 and 431 are loaded as function execution units that correspond to the OS information setting utility 21 of the separate controllers 20. Furthermore, the OS switching user interfaces (UIs) 412, 422 and 432 are loaded as function execution units that correspond to the OS switching interface 22. Since OS#1 and OS#2 employ the suspend function and the resume function that are supported by each OS, so that they are changed from the halted state to the operating state, suspend controllers 413 and 433 and resume controllers 414 and 434 are loaded in the OS#1 logical memory block 410 and the OS#3 logical memory block 430. Since OS#2 does not have the suspend function and the resume function, a suspend controller and a resume controller are not loaded in the OS#2 logical memory block 420.

Further, virtual shut-down controllers 415, 425 and 435 are loaded, so that the individual OSs can be terminated independently, while the overall system continues its operation. As is described above, the virtual shut-down controllers 415 and 435 are not requisite components for OS#1 and OS#3. However, when a change from OS#2, which does not have the suspend function and the resume function, to another OS is effected, the operation by OS#2 should be ended independently and rebooting should be used to shift to the operating state, and for this the virtual shut-down controller 425 must be loaded.

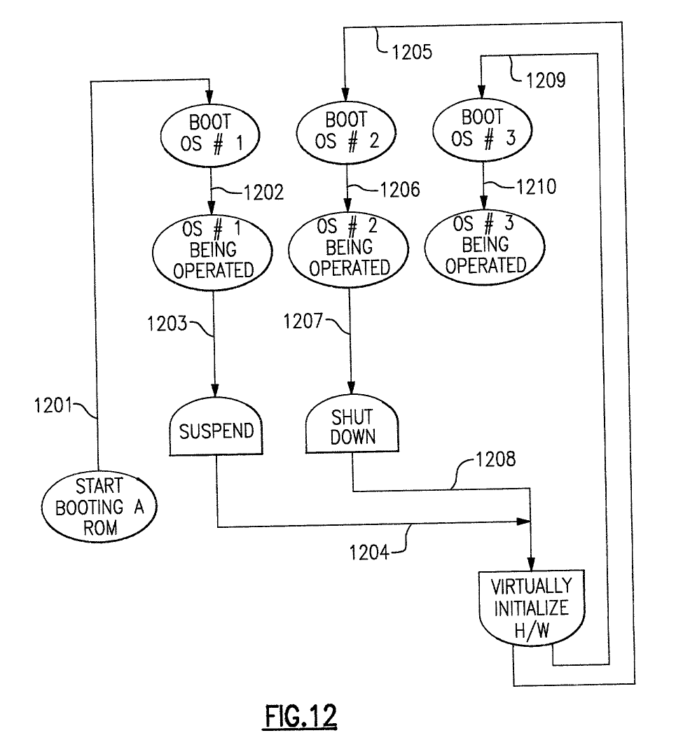

An explanation will now be given for the processing performed in accordance with the embodiment for activating the computer system wherein OS#1, OS#2 and OS#3 coexist. FIG. 11 is a flowchart for explaining the processing for activating the computer system, and FIG. 12 is a diagram for explaining the state shifting when the computer system is activated. For this processing, various methods can be employed to load the multi-OS initialization unit 401, the virtual system initialization unit 402, the logical memory division controller 403, the virtual boot controller 404, the OS switching controller 405, the OS characteristic registration unit 406 and the OS boot loader registration unit 407 into the independent logical memory block 400 of the memory device. In this case, an explanation will be given only for the processing performed when these function execution units are to be loaded into the independent logical memory block 400 with the main OS.

In the flowchart in FIG. 11, steps 1101 to 1106 are the same as steps 501 to 506 in FIG. 5, and steps 1111 to 1115 are the same as steps 508 to 512 in FIG. 5. In this processing, since OS#2 does not have the suspend function and the resume function, at step 1106 the logical memory block for loading the OS is designated, and whether a currently operating OS is to be halted by the suspend function or the pertinent OS is to be terminated is selected (step 1107). When a currently operating OS is to be halted by using the suspend function in the same manner as are OS#1 and OS#3, the pertinent OS is suspended (step 1108).

When the currently operating OS is to be terminated in the same manner as is OS#2, the pertinent OS is independently terminated (step 1109). Then, in either case the system is set to the virtual system initialized state (step 1110), and the storage location of the boot loader of the next OS is specified (step 1111).

This processing will be specifically explained while referring to the state shifting diagram in FIG. 12. For this processing, OS#1, which is the main OS, is activated by the booting of the ROM, and is temporarily shifted to the halted state using the suspend function, and OS#2 is booted by the multi-OS initialization unit 401. Since this process (see 1201 to 1205) is the same as in FIG. 6, no detailed explanation will be given.

When the booting of OS#2 is completed (see 1206), the virtual shut-down controller 425, which is OS switching control code for OS#2, is also ready for execution. Thus, OS#2 employs the virtual shut-down controller 425 for its independent termination. Then, the right of execution is transmitted to the multi-OS initialization unit 401 (see 1207 and 1208). The multi-OS initialization unit 401 retracts the contents (one part of the program for OS#2) in the memory area for a conflict in the independent logical memory block 400, and sets the hardware to the virtual system initialized state (see 1208). Thereafter, the boot loader of OS#3 is developed in the OS#3 logical memory block 430, and the right of execution is shifted (see 1209). As a result, the third OS, OS#3, is set in the operating state (see 1210).

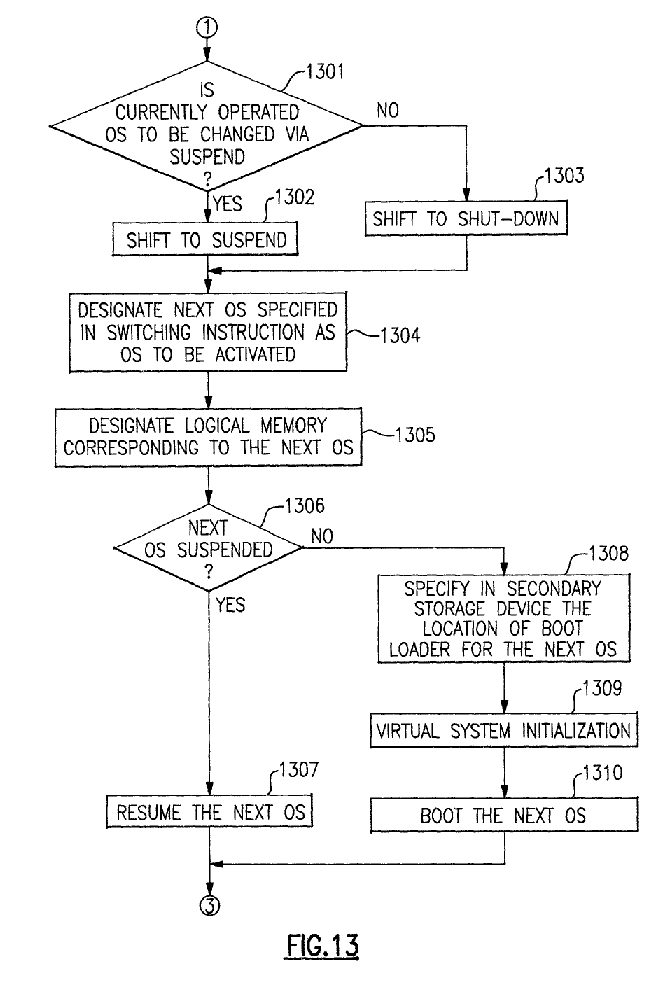

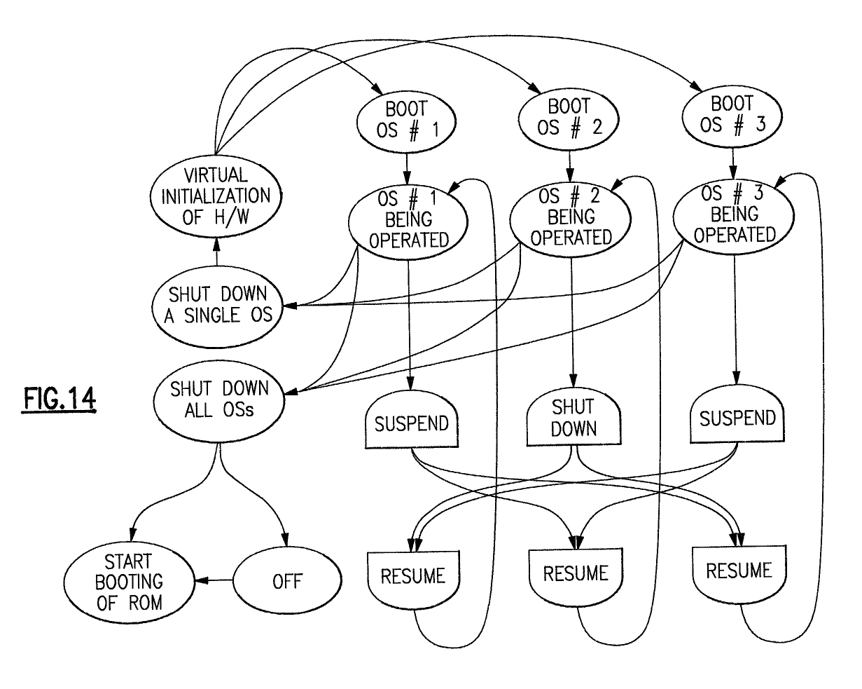

The OS run time switching processing will now be described. FIG. 13 is a flowchart for explaining the OS switching processing, and FIG. 14 is a diagram for explaining the state shifting when OSs are switched In the flowchart in FIG. 11, when at step 1114 an OS change request is issued by the OS switching user interface 412, 422 or 432 for a predetermined OS, program control shifts to the processing in FIG. 13. First, the separate controller 20 determines whether the currently operating OS should be halted using the suspend function, or should be terminated, and in accordance with the determination, the currently operating OS is suspended or terminated (steps 1301, 1302 and 1303).

Then, the right of execution is shifted to the general controller 10, which defines the OS that is designated in the switching request as the next OS to be activated (step 1304). The logical memory block that corresponds to the pertinent OS is then designated (step 1305), and following that a check is performed to determine whether the next OS to be activated will be suspended or halted. If the next OS is temporarily halted by the suspend function, the right of execution is shifted to the separate controller 20, which shifts the next OS to the operating state using the resume function of the pertinent OS (steps 1306 and 1307). When the next OS to be activated is terminated, the position of the secondary storage device in which the boot loader of the pertinent OS is stored is specified (step 1308). The system is then set to the virtual system initialized state (step 1309) and the booting is initiated (step 1310).

This processing will be described while referring to the state shifting diagram in FIG. 14. Since the switching between OS#1 and OS#3 by using the suspend function and the resume function is substantially the same as the process explained while referring to FIG. 8, no explanation for it will be given.

First, the changing to OS#2 will be described. Assume that, while OS#1 is operating, a user employs the OS switching user interface 412 of the OS#1 to request to change from OS#1 to the OS#2. Then, the execution right is shifted to the suspend controller 413 of OS#1, the hardware context of OS#1 is stored, and OS#1 is shifted to the suspended state. Then, execution control is shifted to the general controller 10, which transmits, to the OS switching controller 405 of the independent logical memory block 400, the OS that is designated as the next OS to use by the OS switching user interface 412.

The OS switching controller 405, first determines that the information registered in the OS characteristic registration unit 406 is employed to change from OS#1 to OS#2 by shut-down. In this embodiment, since there are two OSs (OS#1 and OS#3) that employ the suspend function and the resume function for changing OSs, and the OS (OS#2) that employs the shut-down process, the determination of which function the next OS to be activated should employ should always be performed.

Program control is shifted from the OS switching controller 405 to the virtual system initialization unit 402, which initializes the system hardware components other than the memory and the memory controller, so that these components are set when the right of execution is transmitted from the ROM to the OS. That is, the normal booting state viewed from OS#2 is prepared. Then, the address in the secondary storage device in which the boot loader of the OS#2 is stored is obtained from the OS boot loader registration unit 407. Following this, program control is shifted to the virtual boot controller 404, which then accesses the partition at the obtained address to develop the boot loader in the memory. Thereafter, program control is shifted to the boot loader. As a result, the booting of OS#2 is initiated.

When the booting of OS#2 is initiated, OS#2 queries the BIOS concerning the memory configuration. For this query, the BIOS is hooked to the logical memory division controller 403. Thus, OS#2 identifies the logical memory block 420 allocated to it. Specifically, in accordance with OS#2, which is to be booted next, the virtual boot controller 404 reads in advance the OS#2 logical memory block 420 from the OS characteristic registration unit 406, and sets it for the logical memory division controller 403. Since the switching by OS#2 is performed by a shut-down and a reboot, when OS#2 is not operated, the main memory allocated for OS#2 is maintained unused. When the OS#2 has been booted, the switching from the OS#1 to the OS#2 is completed.

The processing for switching the OS#2 to another OS will now be explained. Assume that, while the OS#2 is operating, a user employs the OS switching user interface 422 of OS#2 to request to a switch from OS#2 to OS#3. Since the OS#2 does not employ the suspend function, upon receipt of an instruction from the OS switching user interface 422, the virtual shut-down controller 425 of OS#2 begins the shut-down.

When the shut-down is completed by the virtual shut-down controller 425 of OS#2, program control is shifted to the OS switching controller 405. The OS switching controller 405 then employs the information registered in the OS characteristic registration unit 406 to determine the switching to OS#3 using the suspend function and the resume function. Thus, the right of execution is shifted to the resume controller 434 of OS#3, the state of OS#3 is shifted to the resume state, and the hardware context is restored to the state it occupied when OS#3 was suspended. The memory context of OS#3, which was suspended, was continuously stored while OS#2 was operating, and therefore, when the hardware context has been restored and OS#3 restarts the operation immediately following the last address at which OS#3 was shifted to the suspended state, OS#3 can be restarted in the same manner as when it is resumed from a simple suspended state.

OS#3, which is recovered to the operating state, adjusts the time information for the resume process, or when OS#3 was connected to the network before it was suspended, the network link is recovered to the previous connection state.

As is described above, through the overall control that is exercised by the multi-OS initialization unit 401, the virtual system initialization unit 402, the logical memory division controller 403, the virtual boot controller 404, the OS switching controller 405, the OS characteristic registration unit 406 and the OS boot loader registration unit 407, all of which are loaded into the independent logical memory block 400, and through the boot process in the system virtual initialization state, even an OS that does not have the suspend function and the resume function can be switched to another coexisting OS by the run time OS operation. Since the shut-down and reboot are performed to effect a change from an OS, such as OS#2 in this embodiment, that does not include the suspend function and the resume function, it takes more time than when the suspend function and the resume function can be used to switch OSs. However, when there are few resident programs, or when only a short time is required for the booting and shut-down of an OS, usability is not to greatly deteriorated if such an OS and an OS that employs the suspend function and the resume function coexist. Based on this fact, when an OS that has the suspend function and the resume function is to be recovered to the operating state, the hardware context and the memory context need not be restored to the state that existed immediately before the OS was halted, and the shut-down and the rebooting processes may be employed for the OS switching.

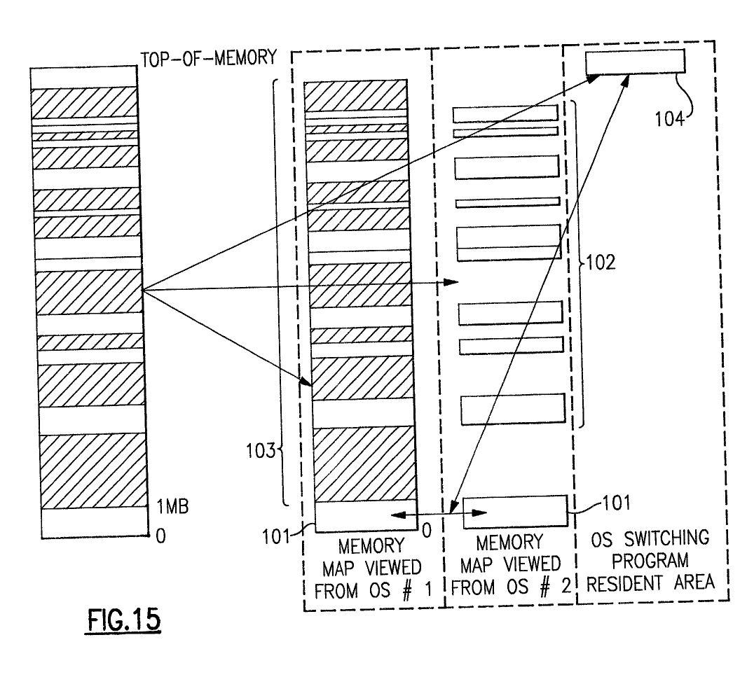

FIG. 15 is a diagram showing another arrangement for a memory map that is logically divided according to the invention, wherein two OSs, OS#1 and OS#2, coexist. In FIG. 15, among memory areas, other than a memory area 101 of 0 to 1 MB that is consistently employed by each OS, and an independent memory area 104 that is used for the OS switching operation, blank areas are memory areas 102 allocated for OS#1, and shaded areas are memory areas 103 allocated for OS#2. As for the relationship between the memory areas 102 and the memory areas 103, one of the OSs, OS#1 or OS#2, obtains a specific virtual memory from the allocated memory areas, and maintains it for the other OS. If OS#2 holds the virtual memory for OS#1, all the areas excluding the memory areas 101 and 104 are initially allocated to OS#2. Then, when OS#2 obtains a specific virtual memory in the pertinent memory areas, the memory area for operating OS#1 is acquired.

Since the memory areas 102 allocated for OS#1 are obtained as virtual memories, as is shown in FIG. 15 they are skipped in the physical address domain. Accordingly, the memory areas 103 are skipped in the physical address domain. However, in the logical address domain handled by each OS, these areas can be employed as continuous memory areas.

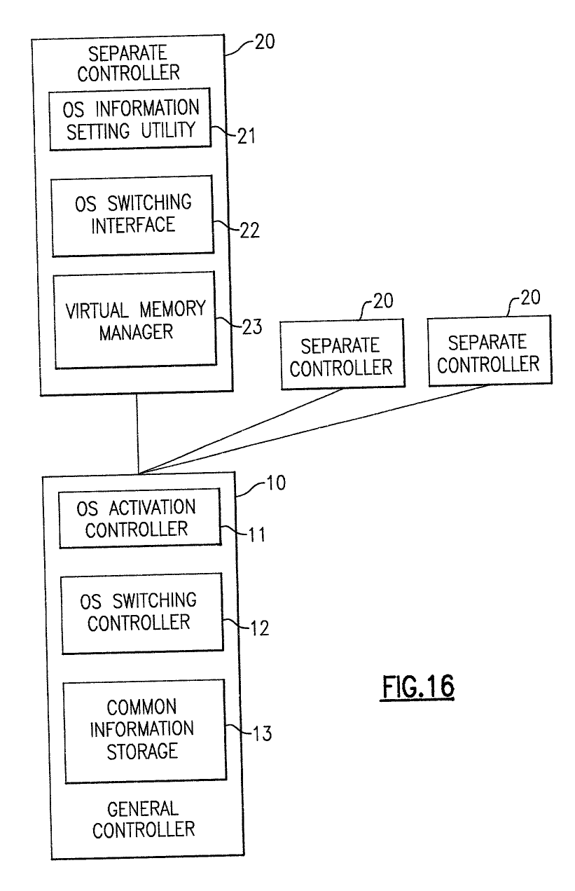

FIG. 16 is a diagram, in accordance with another embodiment, for explaining the system configuration of a computer system wherein multiple OSs coexist. In this embodiment, as in the embodiment in FIG. 3, the computer system comprises a general controller 10, for overall control of the OSs that coexist in the system, and separate controllers 20, which are prepared for the individual OSs. In this example, for the first OS to which a memory area is allocated, virtual memory manager 23 is included to obtain and allocate virtual memory for another OS.

The virtual memory manager 23 is operated by an OS that is loaded into a memory area, other than an independent memory area (the memory area 104 in FIG. 15), of the memory device into which a program that carries out the function of the general controller 10 is loaded. Then, the virtual memory manager 23 obtains virtual memory as a memory area into which another OS is to be loaded.

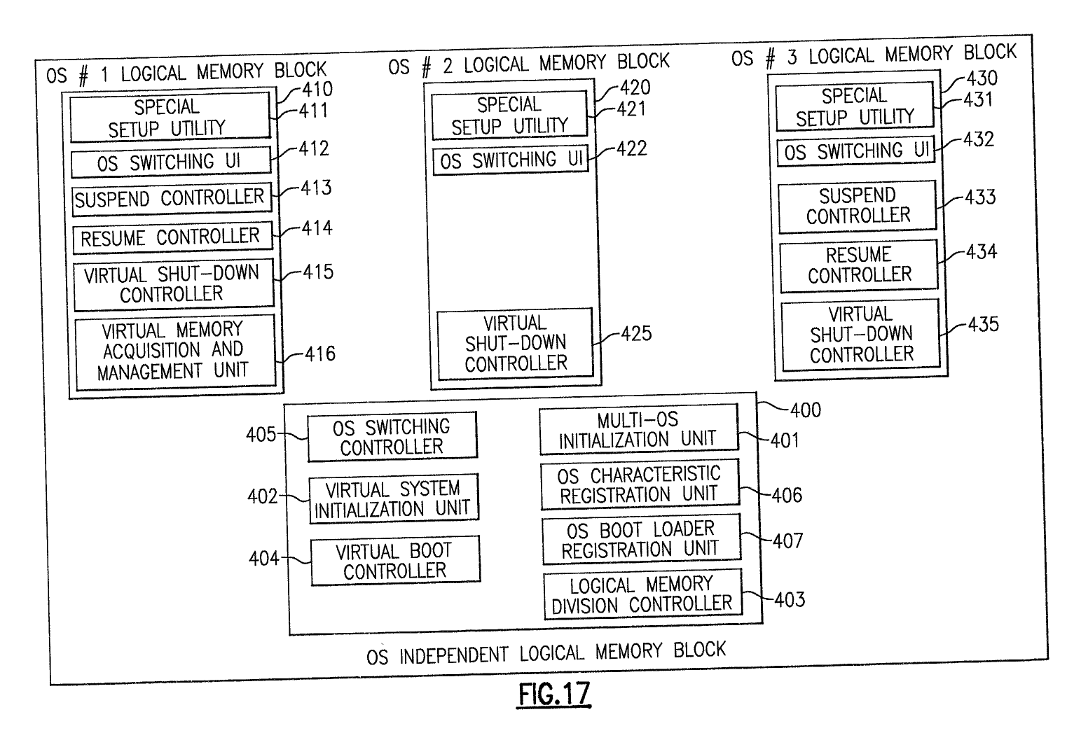

FIG. 17 is a diagram for explaining the arrangement of logical memory blocks in a memory device that is logically divided in accordance with the embodiment. Three OSs, OS#1, OS#2 and OS#3, coexist in the memory device in FIG. 17. Therefore, the memory device includes an OS#1 logical memory block 410, an OS#2 logical memory block 420, an OS#3 logical memory block 430 and an independent logical memory block 400. Although not shown, the memory device also includes a logical memory block used in common by OS#1, OS#2 and OS#3. It should be noted that, when one of the three OSs, OS#1, OS#2 and OS#3, is in the operating state, the logical memory block used in common is employed as the logical memory block for the currently operating OS. Further, the OS#2 logical memory block 420 and the OS#3 logical memory block 430 are constructed in a virtual memory area obtained in the memory area into which OS#1 has been loaded.

In FIG. 17, in the independent logical memory block 400, a multi-OS initialization unit 401, a virtual system initialization unit 402, a logical memory division controller 403 and a virtual boot controller 404 are loaded as the function execution units that correspond to the OS activation controller 11 of the general controller 10. Further, an OS switching controller 405 is loaded as a function execution unit that corresponds to the OS switching controller 12, and an OS characteristic registration unit 406 and an OS boot loader registration unit 407 are loaded as function execution units that correspond to the common information storage 13.

In addition, in the OS#1 logical memory block 410, the OS#2 logical memory block 420 and the OS#3 logical memory block 430, special setup utilities, 411, 421 and 431, are loaded as function execution units that correspond to the OS information setting utility 21 of the separate controllers 20. Furthermore, OS switching user interfaces (UIs) 412, 422 and 432 are loaded as function execution units that correspond to the OS switching interface 22.

Since the suspend function and the resume function that OS#1 and OS#2 support are employed to change the halted state and the operating state of these OSs, suspend controllers 413 and 433 and resume controllers 414 and 434 are loaded into the OS#1 logical memory block 410 and the OS#3 logical memory block 430. Since OS#2 does not have the suspend function and the resume function, a suspend controller and a resume controller are not loaded into the OS#2 logical memory block 420.

Moreover, virtual shut-down controllers 415, 425 and 435 are loaded, so that the individual OSs can be independently terminated while the overall system continues its operation. The virtual shut-down controllers 415 and 435 are not requisite components for OS#1 and OS#3, which have the suspend function and the resume function. However, since for the OS switching operation OS#2 does not have the suspend function and the resume function and rebooting must be used to independently terminate it and shift it to the operating state, the virtual shut-down controller 425 must be loaded.

In the OS#1 logical memory block 410, a virtual memory acquisition and management unit 416 is loaded as a function execution unit that corresponds to the virtual memory manager 23. The virtual memory acquisition and management unit 416, which is operated by OS#1, obtains, in the memory area into which OS#1 has been loaded, a specific virtual memory area in which other OSs (OS#2 and OS#3) are to be loaded. To acquire the virtual memory, as is shown in FIG. 18, a memory acquisition request is issued to the memory manager for OS#1, and the first address and the size of the memory area that is obtained by the memory manager is accepted. In addition, when the system is activated, the virtual memory acquisition and management unit 416 is loaded as OS#1 is booted.

As the virtual memory, a constant area may be obtained and consistently retained, or each time OSs are changed, a virtual memory area may be obtained. Further, a different method may be employed for each OS: for example, a virtual memory area may be consistently prepared for OS#2, while a virtual area for OS#3 may be acquired when the current OS is changed to OS#3. However, for a case where the virtual memory is acquired each time an OS is changed, the virtual memory may be released when the currently operating OS is terminated by returning it directly to OS#1, or completing the change to the other OS and then returning it to OS#1. Thus, when the currently operating OS is terminated, the memory size available for OS#1 or another OS is increased, so that the memory area can be economically employed. A specific method for acquiring virtual memory will be described later.

In this embodiment, various methods can also be employed for loading the function execution units into the independent logical memory block 400 in FIG. 17, or for loading the function execution units with a specific OS or for loading these units into the independent logical memory block 400 first. However, since OS#1 is loaded by using all the memory areas other than the independent logical memory block 400, it is easy to employ the method for booting the OS#1 first and for sequentially loading the function execution units into the independent logical memory block 400. In this case, since the program that carries out each function execution unit in the independent logical memory block 400 is initially loaded as an OS#1 file, OS#1 can be booted without being aware of the memory areas that are to be loaded.

FIG. 19 is a flowchart for explaining the processing performed by the virtual memory acquisition and management unit 416 to obtain virtual memory. This processing is called by the suspend controller 413 when program control is shifted to the suspend controller 413 to switch OS#1 to the halted state. In FIG. 19, first, the type of virtual memory to be obtained is set as a pageable memory (step 1901). Then, a check is performed to determine the employment frequency of the next OS to be activated, i.e., whether the pertinent OS will not be used for a while after its most recent use, or whether it will be used frequently by switching (step 1902). When the employment frequency of the next OS is high, a check is performed to determine whether the next OS to be activated employs the suspend function to shift to the halted state (step 1903). When the pertinent OS employs the suspend function, the type of virtual memory is re-set as non-pageable memory (step 1904). When the employment frequency of the next OS to be activated is low, or when the pertinent OS does not employ the suspend function to shift to the halted state, the type of virtual memory to be obtained is maintained as pageable memory.

The type of initially acquired virtual memory is set as pageable memory because pageable memory is inexpensive and is easier for the memory manager of the OS to obtain. However, pageable memory will probably be swapped out by the memory manager without notice to the virtual memory acquisition and management unit 416 which is a source device driver. That is, when pageable memory is acquired immediately before a currently operating OS is replaced and that memory area is provided for a different OS, it is highly probable that the pageable memory will be swapped out when another OS change occurs and the initial OS is again operated. Therefore, when an OS is changed back to a previous OS, the pageable memory may not be in the same physical memory area as before or may continue to be swapped out and may not be actually allocated in any physical memory area. On the other hand, non-pageable memory does not accept any intervention once it is obtained. Thus, when the next OS to be operated is frequently used, and when the OS context is to be stored by using the suspend function when the OS is halted, the type of virtual memory to be acquired must be changed to non-pageable memory.

Even when OS switching is performed so that an OS is used only one time, if a large virtual memory is required, the pageable memory area that is needed may not actually be obtained. This is because the method that is generally adopted for virtual memory management is one whereby, when an OS is employed, virtual memory is obtained by swapping out memory that is currently being used for another application. Therefore, in the example for obtaining pageable memory in FIG. 19, depending on various factors, such as the total size of the memory mounted in the pertinent machine, the size of the requested virtual memory and the state of another task that is currently being performed, non-pageable memory may be requested.

Information concerning the employment frequency of an OS and whether an OS employs the suspend function can be set in the special setup utilities 411, 421 and 431 for the individual OSs, and can be registered in the OS characteristic registration unit 406.

When the type of virtual memory to be obtained is determined, the size of the memory required by the OS that is loaded is obtained from the logical memory division controller 403 (step 1905). Then, the correct amount of virtual memory is acquired from the OS#1 memory manager (step 1906), and the logical memory block in the virtual memory for a target OS is returned to the suspend controller 413 (step 1907).

As is described above, before OS#1 is shifted to the halted state, the above processing is performed in response to a call issued by the suspend controller 413. Specifically, the OS switching event is initiated upon the receipt of a request from the OS#1 switching user interface 412, and in accordance with the OS switching event, the above processing is requested each time and is executed by the suspend controller 413. This is appropriate in a case wherein the employment frequency is low for an OS that is to be switched to, and where for the efficient use of memory it is not preferable that a memory area be acquired and retained for use by an OS beginning at the time the system was activated.

For a case wherein it is understood that the employment frequency of the OS is high and that the suspend function is employed for OS switching, when OS#1 is booted, the non-pageable memory may be acquired in advance by an initial routine performed by the virtual memory acquisition and management unit 416. This method is appropriate for a case wherein a predetermined OS and OS#1 are designated in advance, i.e., wherein among multiple coexisting OSs, including OS#1, the employment frequency does not differ very much.

An explanation will now be given for the process for releasing virtual memory that is obtained to load an OS. When an additional OS that was called and was used only one time has been terminated, or when a pertinent OS does not have the suspend function so that the shut-down and rebooting processes must be performed to change the OS, it is inefficient to obtain and hold virtual memory. Thus, when the OS that was called is replaced by OS#1, the virtual memory that was obtained for the pertinent OS is released.

Further, when together with a switching instruction a message that the use of the OS (OS#2 or OS#3) that was called is not currently planned is issued by the user through the corresponding OS switching user interface 422 or 432, the message is transmitted via the logical memory division controller 403 to OS#1. Upon the receipt of this message, the OS#1 resume controller 414 instructs the virtual memory acquisition and management unit 416 to request that the OS#1 memory manager release the virtual memory.

Other operations in this embodiment, i.e., the booting of individual OSs and the loading of function execution units into the independent logical memory block 400 when the system is activated, the operations performed by the suspend controllers 413 and 433, the resume controllers 414 and 434 and the virtual shut-down controller 425 and the OS switching controller 405 when the OSs are switched at run time, are the same as those explained while referring to FIGS. 5 to 9 and FIGS. 11 to 14, so that no explanation for them will be given.

In the above embodiments, a memory area is allocated for each OS by the OS information setting utility (a special setup utility) and is registered in the common information storage, and when the OS is booted, the information in the corresponding logical memory area is referred to. Various methods can be employed to correlate the OSs with the logical memory blocks. For example, the order in which OSs are booted may be determined in advance, and the allocated logical memory blocks may be consistently returned to the individual OSs in accordance with the booting order. Or, the ID information for the OSs may be set, and a logical memory block that is registered in advance may be correlated with the OSs by using an ID. In addition, if the design of an OS is based on the premise that it will function in coexistence with other OSs, the OS may request from a system a memory area having an appropriate (or a minimum required) size.

As is described above, according to the present invention, an environment can be provided wherein for employment, switching among a plurality of coexisting operating systems provided for a single computer system can be performed at high speed.

Further, the state of an OS that is being employed can be stored before the OS is switched for one of the other OSs that coexist in a single computer system, and the stored state of the pertinent OS can be recovered when the OS is again switched with another, preceding OS and is again employed.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A computer system on which a plurality of operating systems are mounted and that switches among and employs said plurality of operating systems, comprising:
a memory device, which has a memory area that is logically divided to obtain a plurality of operating system memory areas, each of which respectively corresponds to one of said plurality of operating systems, and an independent memory area that does not correspond to any of said plurality of operating systems;
an interface which is operated by each of said plurality of operating systems that are independently loaded into said operating system memory areas, said interface issuing an instruction for changing the current operating system;
a suspend controller which is operated by each of said operating systems that are independently loaded into said operating system memory areas, said suspend controller storing, in an operating system memory area assigned to an initial operating system, information concerning the operational context of said initial operating system and for temporarily halting said initial operating system;
a resume controller which is operated by each of said operating systems that are independently loaded into said operating system memory areas, said resume controller shifting to an operating state said initial operating system that has been temporarily shifted to the halted state and for employing said information, which concerns said operational context of said initial operating system that is stored in said operating system memory area, to recover said operational context that existed immediately before said initial operating system was temporarily shifted to the halted state; and
an operating system switching controller which is operated independently of all of said operating systems, said operating switching controller receiving from said interface an instruction to switch said operating systems, said operating system switch, when an operating system that has issued said switching instruction is temporarily shifted to said halted state by said suspend controller, employing the resume controller, of a different operating system that is designated in said instruction, to shift said different operating system to an operating state.

2. The computer system according to claim 1, wherein, when a specific memory area of said memory areas controlled by said memory device is repetitively employed by said plurality of operating systems, before said different operating system is shifted to the operating state, said operating system switch withdraws, to said independent memory area or to a primary storage device, the contents of said specific memory area that were loaded by said operating system that was temporarily shifted to the halted state.

3. A computer system, on which a plurality of operating systems are mounted and which switches among and employs said operating systems, comprising:
a memory device, which has a memory area that is logically divided to obtain a plurality of operating system memory areas, each of which respectively corresponds to one of said plurality of operating systems, and an independent memory area that does not correspond to any of said plurality of operating systems;
a virtual memory manager acquiring, as virtual memory, a memory area into which a main operating system, which, when said computer system is activated, is booted and occupies a corresponding operating system memory area, loads another operating system;
a suspend controller storing, in said operating system memory area, information concerning the operational context of said initial operating system, and for temporarily halting said operating system; and
a resume controller shifting said operating system that is temporarily halted to an operating state, and employing said information, which concerns said operational context of said initial operating system that is stored in said operating system memory area, to restore said operational context that was retracted immediately before said initial operating system was shifted to the temporarily halted state,
wherein, when said main operating system is changed to a different operating system, said virtual memory manager obtains a virtual memory area for said different operating system,
wherein said suspend controller temporarily halts said main operating system, and said different operating system is loaded into said virtual memory area, and
wherein, when said different operating system is to be replaced by said main operating system, said resume controller waiting until said different operating system is halted, and then shifting said main operating system into an operating state.

4. For a computer system in which a plurality of operating systems are mounted, a system for switching said operating systems that are to be used comprising:
a memory device, which has a memory area that is logically divided to obtain a plurality of operating system memory areas, each of which respectively corresponds to one of said plurality of operating systems, and an independent memory area that does not correspond to any of said plurality of operating systems; and
an operating system switching controller switching an operating system that is loaded in one of said operating system memory areas with an operating system that is loaded in said independent memory area,
wherein, for an operating system having a suspend function that stores, in an operating system memory area assigned for an initial operating system, information concerning the operational context of said initial operating system and that temporarily halts said initial operating system, and having a resume function that shifts said initial operating system that is temporarily halted to an operating state and that employs said information concerning said operational context of said initial operating system to restore said operational context that existed immediately before said initial operating system was temporarily shifted to the halted state, when said operating system switching controller employs said suspend function to temporarily halt said initial operating system in order to change from said initial operating system to a different operating system, and
wherein said operating system switching controller employs said resume function to shift said initial operating system to the operating state in order to change from said different operating system to said initial operating system.

5. The operating system switching system according to claim 4, wherein, for an operating system that does not have said suspend function and said resume function, said operating system switching controller independently shuts down and halts said operating system in order, for use, to change from said operating system to a different operating system, or reboots said operating system and shifts to said different operating system in order to change from said different operating system to said operating system.

6. For a computer system in which a plurality of operating systems are mounted and which switches among and employs said operating systems, an operating system mounting method comprising the steps of:
loading, into a predetermined memory area belonging to a memory device, means for exercising overall control, which is a program module for totally controlling the booting and switching of said plurality of operating systems; and
sequentially loading, under the control of said means for exercising overall control, said operating systems into a plurality of operating system memory areas in said memory device that respectively correspond to said operating systems,
whereof said step of sequentially loading said operating systems includes the steps of
employing a boot loader for a specific operating system to boot each of said operating systems in a corresponding operating system memory area,
halting said operating system that has been booted when there is a different operating system to be loaded, and
initializing, after said operating system has been halted, hardware components, other than said memory device and a memory controller, to shift program control to a process for loading said different operating system.

7. The operating system mounting method according to claim 6, wherein said step of halting said operating system that is booted includes the steps of:
temporarily shifting said operating system to the halted state if said operating system that is booted has a suspend function, which can store information concerning the operational context of an initial operating system in an operating system memory area that is assigned thereto and which temporarily halts said initial operating system, and a resume function, which shifts said initial operating system to the operating state and which employs said information concerning said operational context of said initial operating system to restore said operational context that existed immediately before said initial operating system was shifted to the temporarily halted state; and
independently shutting down said operating system if said operating system does not have said suspend function and said resume function.

8. For a computer system in which a plurality of operating systems are mounted and which switches among and employs said operating systems, an operating system mounting method comprising the steps of:
booting an operating system having a memory device that has a virtual memory management function for obtaining a predetermined memory area as virtual memory;
employing said virtual memory management function of said booted operating system to acquire, as virtual memory, a memory area having a predetermined size in order to use a different operating system;
storing, in said memory area that was acquired as said virtual memory, information concerning the operational context of said booted operating system, and temporarily halting said operating system;
booting, after said operating system has been temporarily halted, said different operating system in said memory area that was obtained as said virtual memory;
halting, after said different operating system has been used, said different operating system and shifting said temporarily halted operating system to the operating state, and employing for said temporarily halted operating system said information concerning said operational context, which was stored in said memory area, in order to recover said operational context that existed immediately before said operating system was temporarily shifted to the halted state.

9. For a computer system in which a plurality of operating systems are mounted and which switches among and employs said operating systems, an operating system switching method comprising the steps of:
issuing a request for changing from a specific operating system, which is in the operating state, to a different operating system selected from among said plurality of operating systems, which are loaded into corresponding operating system memory areas that are provided by logically dividing a memory area belonging to a memory device;
shifting said operating system in said operating state to the halted state; and
shifting said different operating system to the operating state,
wherein, if said operating system to be switched to the halted state has a suspend function, which stores information concerning the operational context of an initial operating system in a corresponding operating system memory area and temporarily halts said initial operating system, said step of shifting said operating system to the halted state includes the step of employing said suspend function to temporarily shift said operating system to the halted state,
wherein, if said different operating system has a resume function, which shifts to the operating state an initial operating system that was temporarily halted by said suspend function and which employs information concerning the operational context of an initial operating system, stored in a corresponding operating system memory area, in order to recover said operational context that existed immediately before said initial operating system was temporarily shifted to the halted state, said step of temporarily shifting said operating system to the halted state includes the step of employing said resume function to shift said different operating system to the operating state.

10. For a computer system in which a plurality of operating systems are mounted and which switches among and employs said operating systems, an operating system switching method comprising the steps of:
issuing a request for changing from a specific operating system, which is in the operating state, to a different operating system selected from among said plurality of operating systems, which are loaded into corresponding operating system memory areas that are provided by logically dividing a memory area belonging to a memory device;
shifting said operating system in said operating state to the halted state; and
shifting said different operating system to the operating state,
wherein, if said operating system to be switched to the halted state does not have a suspend function, which stores information concerning the operational context of an initial operating system in a corresponding operating system memory area and temporarily halts said initial operating system, said step of shifting said operating system to the halted state includes the step of shutting down said operating system independently to temporarily shift said operating system to the halted state,
wherein, if said different operating system does not have a resume function, which shifts to the operating state an initial operating system that was temporarily halted by said suspend function and which employs information concerning the operational context of an initial operating system, stored in a corresponding operating system memory area, in order to recover said operational context that existed immediately before said initial operating system was temporarily shifted to the halted state, said step of temporarily shifting said operating system to the halted state includes the step of rebooting said different operating system to shift said different operating system to the operating state.

11. A storage medium on which input means for a computer stores a computer-readable program, said computer-readable program permitting said computer to perform:
a first process for logically dividing a memory area belonging to a memory device to obtain a plurality of operating system memory areas that respectively correspond to a plurality of operating systems; and
a second process for sequentially loading said operating systems into said corresponding operating system memory areas, said second process including
a process for employing a boot loader for a specific operating system to boot each of said operating systems in a corresponding operating system memory area,
a process for, when there is a different operating system to be loaded, halting said operating system that has been booted, and
a process for, after said operating system has been halted, initializing hardware components, other than said memory device and a memory controller, in order to shift program control to a process for loading said different operating system.

12. The storage medium according to claim 11, wherein said process for halting said operating system that is booted includes:
a process for temporarily shifting said operating system to the halted state if said operating system that is booted has a suspend function, which stores information concerning the operational context of an initial operating system in an operating system memory area that is assigned thereto and which temporarily halts said initial operating system, and a resume function, which shifts said initial operating system to the operating state and which employs said information concerning said operational context of said initial operating system to restore said operational context that existed immediately before said initial operating system was shifted to the temporarily halted state; and
a process for independently shutting down said operating system if said operating system does not have said suspend function and said resume function.

13. A storage medium on which input means for a computer stores a computer-readable program, said computer-readable program permitting said computer to perform:
a process for accepting a request to switch from a specific operating system, which is in the operating state, to a different operating system selected from among operating systems that are loaded into corresponding operating system memory areas, which are obtained by logically dividing a memory area belonging to a memory device;
a process for, if said operating system to be switched has a suspend function for storing information concerning the operational context of an initial operating system in a corresponding operating system memory area and for temporarily halting said initial operating system, employing said suspend function to shift said specific operating system to the halted state; and
a process for, if said different operating system has a resume function for shifting to the operating state an initial operating system that has temporarily been halted by said suspend function and for employing information concerning the operational context of an initial operating system stored in a corresponding operating system memory area in order to recover operational context that existed immediately before said initial operating system was shifted to the temporarily halted state, employing said resume function to shift said different operating system to the operating state.

14. A program transmission apparatus comprising:
storage means for storing a program that permits a computer to perform
a first process for logically dividing a memory area belonging to a memory device to obtain a plurality of operating system memory areas that respectively correspond to a plurality of operating systems, and
a second process for sequentially loading said operating systems into said corresponding operating system memory areas, said second process including
a process for employing a boot loader for a specific operating system to boot each of said operating systems in a corresponding operating system memory area,
a process for, when there is a different operating system to be loaded, halting said operating system that has been booted, and
a process for, after said operating system has been halted,
initializing hardware components, other than said memory device and a memory controller, in order to shift program control to a process for loading said different operating system; and
transmission means for reading said program from said storage means and for transmitting said program.

15. The program transmission apparatus according to claim 14, wherein said process for halting said operating system that is booted includes:
a process for temporarily shifting said operating system to the halted state if said operating system that is booted has a suspend function, which stores information concerning the operational context of an initial operating system in an operating system memory area that is assigned thereto and which temporarily halts said initial operating system, and a resume function, which shifts said initial operating system to the operating state and which employs said information concerning said operational context of said initial operating system to restore said operational context that existed immediately before said initial operating system was shifted to the temporarily halted state; and
a process for independently shutting down said operating system if said operating system does not have said suspend function and said resume function.

16. A program transmission apparatus comprising:
storage means for storing a program that permits a computer to perform
a process for accepting a request to switch from a specific operating system, which is in the operating state, to a different operating system selected from among operating systems that are loaded into corresponding operating system memory areas, which are obtained by logically dividing a memory area belonging to a memory device,
a process for, if said operating system to be switched has a suspend function for storing information concerning the operational context of an initial operating system in a corresponding operating system memory area and for temporarily halting said initial operating system, employing said suspend function to shift said specific operating system to the halted state, and
a process for, if said different operating system has a resume function for shifting to the operating state an initial operating system that has temporarily been halted by said suspend function and for employing information concerning the operational context of an initial operating system stored in a corresponding operating system memory area in order to recover operational context that existed immediately before said initial operating system was shifted to the temporarily halted state, employing said resume function to shift said different operating system to the operating state; and
transmission means for reading said program from said storage means and for transmitting said program.
